(19) United States
(12) Patent Application Publication
(10) Pub. No.: US 2025/0035452 A1
(43) Pub. Date: Jan. 30, 2025

(54) INCORPORATION OF SD-WAN QUALITY OF SERVICE INTO MAPPING APPLICATION ROUTE OPTIMIZATION

(71) Applicant: VMware LLC, Palo Alto, CA (US)

(72) Inventor: Daniel J. Beveridge, Valrico, FL (US)

(21) Appl. No.: 18/225,720

(22) Filed: Jul. 25, 2023

(51) Int. Cl. G01C 21/34

(52) U.S. Cl. CPC G01C 21/3461

(57) ABSTRACT

Some embodiments provide a novel method for selecting a route for a vehicle traveling from a first location to a second location. For each of a set of two or more candidate navigation routes from the first location to the second location, the method computes (1) a first-metric route score representing a first quality of the candidate navigation route according to a first set of route navigation metrics relating to the vehicle's navigation from the first location to the second location, and (2) a second-metric route score representing a second quality of the candidate navigation route according to a second set of wireless connectivity metrics relating to connectivity of one or more wireless devices operating in the vehicle. Based on the first and second metric route scores, the method uses one navigation route to provide navigation instructions for the vehicle's navigation from the first location to the second location.

### BACKGROUND

Traditional mapping service applications make implicit assumptions about a vehicle's routing requirements. In some embodiments, mapping service applications focus only on transportation considerations, such as trip duration, hazard avoidance, congestion, transit fees etc. However, as computing operations move to edge routers (and more specifically to “roaming” edge routers executing in vehicles in motion), it is becoming increasingly critical that mapping applications consider the reliability and performance of the vehicle's network connectivity when considering which routes the vehicle should traverse.

Software-defined wide area network (SD-WAN) technology makes such route determinations more complex, as vehicles can utilize multiple carriers and multiple carrier connections with one SD-WAN router (software or hardware) executing in the vehicle. These multiple carrier connections allow the SD-WAN router to dynamically distribute data message flows among the various connections on a real-time basis. As 5G and future next-G technologies are deployed into the landscape, there will be a broad mix of speeds and connection types dynamically available to vehicles. Hence, methods and systems are needed for selecting optimal routes based on both transportation considerations and network connection considerations.

### BRIEF SUMMARY

Some embodiments provide a novel method for selecting a route for a vehicle traveling (e.g., navigating) from a first location to a second location. For each of a set of two or more candidate network routes from the first location to the second location, the method (1) computes, for the candidate network route, a first-metric route score representing a first quality of the candidate network route according to a first set of one or more route navigation metrics (e.g., route traversal metrics) relating to the vehicle's navigation from the first location to the second location, and (2) computes, for the candidate network route, a second-metric route score representing a second quality of the candidate network route according to a second set of one or more wireless connectivity metrics relating to connectivity of one or more wireless devices operating in the vehicle. Based on the computed first and second metric route scores, the method uses one route from the set of candidate network routes to provide navigation instructions for the vehicle's travel from the first location to the second location.

In some embodiments, the vehicle includes an edge router that forwards data message flows from a set of one or more machines, executing on a device operating in the vehicle, to a software-defined wide area network (SD-WAN) using multiple wireless network links. The method is performed in some embodiments by a mapping service application implemented by a set of processes of the device. In some embodiments, the mapping service executes as a service engine on the device in the vehicle. In other embodiments, it executes as a service virtual machine (SVM) on the device in the vehicle. In different embodiments, the edge router is one of (1) an edge router appliance, (2) an edge router that executes on a computer that operates in the vehicle, or (3) an edge router that executes on a machine that executes on the computer. The device is in some embodiments a computer. The set of machines in different embodiments includes one or more of virtual machines (VMs), Pods, and containers.

The mapping service in some embodiments determines the set of candidate network routes based on a set of quality of service (QOS) requirements of the set of machines. These QoS requirements are specified by the user of the vehicle through a user interface (UI). For example, a machine in some embodiments requires a minimum signal strength of the wireless network links such that each candidate network route must meet the minimum signal strength at each location along the candidate network route. As another example, a machine in some embodiments requires a minimum speed of the wireless network links such that each candidate network route must meet the minimum bandwidth at each location along the candidate network route. Still, as another example, a machine in some embodiments requires both a minimum signal strength and a minimum speed of the wireless network links such that each candidate network route must meet the minimum signal strength and the minimum speed at each location along the candidate network route. Any number of machines can require any number of QOS requirements.

In some embodiments, the set of wireless connectivity metrics include metrics related to one or more of signal strength and speed of the wireless network links. These metrics indicate the wireless signal strength of the wireless network links along various locations along the candidate network route. In some embodiments, the mapping service determines first second-metric route score for each candidate network route by (1) collecting signal strength and speed metrics for each wireless network link indicating the signal strength and speed of the wireless network link at various locations along the candidate network route, (2) using the collected signal strength metrics for the wireless network links to determine an average signal strength of the wireless network links along the candidate network route, (3) using the collected speed metrics for the wireless network links to determine an average speed of the wireless network links along the candidate network route, and (4) aggregating the average signal speed and the average speed to compute the second-metric route score for the candidate network route. By determining the second-metric route score using these operations, the mapping service determines a second-metric route score that considers both the signal strength and the speed of each wireless network links.

The signal strength and speed metrics are collected in some embodiments by sending an Application Programming Interface (API) request to a networking interface to request the signal strength and speed metrics, and receiving an API response from the networking interface comprising the requested signal strength and speed metrics. This networking interface in some embodiments maintains a cloud-based data store that stores various signal strength and speed metrics for various wireless network links at various locations. For instance, each wireless network link used in the vehicle is associated with a different carrier in some embodiments. In such embodiments, the mapping service retrieves metrics collected at different locations for those different carriers in order to score the wireless network links on their signal strength and speed.

In some embodiments, the first-metric route score for each candidate network route indicates how well the candidate network route's path compares to other candidate network routes' paths. The set of route navigation metrics in some embodiments includes metrics related to one or more of time duration of the candidate network route, speed along the candidate network route, traffic along the candidate network route, an amount of fuel to be used along the candidate network route, and a number of stops along the candidate network route. By computing a first-metric route score based on these route navigation metrics (i.e., route travel metrics), the mapping service quantifies the geographic performance of the candidate network routes.

The first-metric route score is computed in some embodiments by (1) determining a time duration for the candidate network route, and (2) normalizing the time duration to compute the first-metric route score. In order to compare each candidate network route based on its time duration, some embodiments normalize the value of the time durations into a scale (e.g., 1-10). In some embodiments, first-metric route scores are computed for the candidate network route by (1) determining a time duration for each candidate network route, (2) ordering the set of candidate network routes according to the determined time durations into an ordered set of candidate network routes, and (3) scoring each candidate network route based on its ordering in the ordered set of candidate network routes. By computing first-metric route scores using these operations, the mapping service scores short candidate network routes higher than longer candidate network routes.

In some embodiments, a first candidate network route that has a longer time duration than a second candidate network route has a lower first-metric route score than the second candidate network route. In such embodiments, a lower route score is a better route score. In other embodiments, a first candidate network route that has a shorter time duration than a second candidate network route has a higher first-metric route score than the second candidate network route because a higher route score is a better route score. First-metric route scores in other embodiments are determined by (1) determining a distance length for each candidate network route, (2) ordering the set of candidate network routes according to the determined distance lengths into an ordered set of candidate network routes, and (3) scoring each candidate network route based on its ordering in the ordered set of candidate network routes.

Before computing the first and second metric route scores, some embodiments receive, from a user of the vehicle through a UI, a request to provide optimal navigation instructions for the vehicle's travel from the first location to the second location. In some of these embodiments, the request is sent by the user using an API request. In other embodiments, the UI is a GUI, and the request is sent by the user using one or more selectable items in the GUI.

In some embodiments, for each candidate network route, the method aggregates the first and second metric route scores using a set of weights to compute an overall score for the candidate network route. In such embodiments, the method uses the one route to provide the navigation instructions based on the computed first and second metric route scores by selecting a particular candidate network route that has a best overall score as the one route. For instance, the user of the vehicle in some embodiments specifies weights for the first and second metric route scores such that the optimal score is influenced more by one of the scores than the other.

For example, a first weight is associated in some embodiments with the first-metric route score and a second, lower weight is associated with the second-metric route score. In such embodiments, the overall score is affected more by the first-metric route score than the second-metric route score. Alternatively, a first weight is associated in other embodiments with the first-metric route score and a second, higher weight is associated with the second-metric route score. In these embodiments, the overall score is affected more by the second-metric route score than the first-metric route score. This allows the user to receive a more custom optimal route to reach the second location.

In some embodiments, the navigation instructions provided for the vehicle's travel from the first to the second location include turn-by-turn instructions including at least one of visual output and audio output to a UI. In other embodiments, the navigation instructions only display the route navigated on a screen through the UI.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an example vehicle and controller cluster for which some embodiments of the invention are implemented.

FIGS. 2 and 3 illustrate an example vehicle that communicates with various components of an SD-WAN.

FIG. 4 illustrates an example of N vehicles that communicate with various components of an SD-WAN.

FIG. 5 conceptually illustrates a process of some embodiments for configuring an edge router of a vehicle.

FIG. 6 conceptually illustrates a process of some embodiments for selecting one of several links for forwarding data message flows.

FIG. 7 illustrates an example flow being sent along different telecommunication network links from a vehicle to a destination router of an SD-WAN.

FIG. 8 illustrates an example vehicle that uses deep packet inspection (DPI) to forward flows from the vehicle to a destination in an SD-WAN using different telecommunication network links.

FIG. 9 illustrates example data messages that are embedded with sequence numbers for a destination router to re-sequence and forward to a subsequent destination in the correct order.

FIG. 10 illustrates an example vehicle selecting different links at different times for forwarding data message flows.

FIG. 11 illustrates an example vehicle selecting different links at different locations for forwarding data message flows.

FIG. 12 conceptually illustrates a process of some embodiments for generating metrics for network links.

FIG. 13 illustrates an example vehicle travelling along a route for which link selections have been predicted.

FIG. 14 conceptually illustrates a process of some embodiments for proactively selecting links along various locations of a future route of a vehicle.

FIG. 15 illustrates an example vehicle travelling along a route in which a future location does not have a predicted link selection.

FIG. 16 conceptually illustrates a process of some embodiments for dynamically distributing data message flows across multiple network links by predicting metrics of each network link at future locations of the vehicle.

FIG. 17 illustrates an example linear regression graph generated for predicting metrics of a particular link at a vehicle's future location.

FIG. 18 illustrates an example vehicle that includes a mapping service application for determining optimal routes based on transportation factors and signal quality factors.

FIG. 19 conceptually illustrates a process of some embodiments for determining an optimal route for a vehicle to travel from a first geographic location to a second geographic location.

FIG. 20 an example mapping service that determines optimal routes for a moving vehicle.

FIG. 21 conceptually illustrates a process of some embodiments for determining a set of candidate network routes to a desired destination for a vehicle.

FIG. 22 conceptually illustrates a process of some embodiments for calculating route scores for a set of two or more candidate network routes.

FIG. 23 illustrates an example table that specifies candidate network routes ordered by time duration and their router scores.

FIG. 24 conceptually illustrates a process of some embodiments for calculating a signal score for a particular candidate network route.

FIG. 25 illustrates an example table that specifies various signal scores computed for a particular candidate network route by a mapping service.

FIG. 26 illustrates a set of candidate network routes for which a mapping service has determined for a vehicle to travel from a first location to a second location.

FIG. 27 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method for selecting a route for a vehicle traveling from a first location to a second location. For each of a set of two or more candidate network routes from the first location to the second location, the method (1) computes, for the candidate network route, a first-metric route score representing a first quality of the candidate network route according to a first set of one or more route navigation metrics relating to the vehicle's navigation from the first location to the second location, and (2) computes, for the candidate network route, a second-metric route score representing a second quality of the candidate network route according to a second set of one or more wireless connectivity metrics relating to connectivity of one or more wireless devices operating in the vehicle. Based on the computed first and second metric route scores, the method uses one route from the set of candidate network routes to provide navigation instructions for the vehicle's travel from the first location to the second location.

In some embodiments, the vehicle includes an edge router that forwards data message flows from a set of one or more machines, executing on a device operating in the vehicle, to a software-defined wide area network (SD-WAN) using multiple wireless network links. The method is performed in some embodiments by a mapping service application implemented by a set of processes of the device. In some embodiments, the mapping service executes as a service engine on the device in the vehicle. In other embodiments, it executes as a service virtual machine (SVM) on the device in the vehicle. In different embodiments, the edge router is one of (1) an edge router appliance, (2) an edge router that executes on a computer that operates in the vehicle, or (3) an edge router that executes on a machine that executes on the computer. The device is in some embodiments a computer. The set of machines in different embodiments includes one or more of virtual machines (VMs), Pods, and containers.

The mapping service in some embodiments determines the set of candidate network routes based on a set of quality of service (QOS) requirements of the set of machines. These Qos requirements are specified by the user of the vehicle through a user interface (UI). For example, a machine in some embodiments requires a minimum signal strength of the wireless network links such that each candidate network route must meet the minimum signal strength at each location along the candidate network route. As another example, a machine in some embodiments requires a minimum speed of the wireless network links such that each candidate network route must meet the minimum bandwidth at each location along the candidate network route. Still, as another example, a machine in some embodiments requires both a minimum signal strength and a minimum speed of the wireless network links such that each candidate network route must meet the minimum signal strength and the minimum speed at each location along the candidate network route. Any number of machines can require any number of QoS requirements.

In some embodiments, the set of wireless connectivity metrics include metrics related to one or more of signal strength and speed of the wireless network links. These metrics indicate the wireless signal strength of the wireless network links along various locations along the candidate network route. In some embodiments, the mapping service determines first second-metric route score for each candidate network route by (1) collecting signal strength and speed metrics for each wireless network link indicating the signal strength and speed of the wireless network link at various locations along the candidate network route, (2) using the collected signal strength metrics for the wireless network links to determine an average signal strength of the wireless network links along the candidate network route, (3) using the collected speed metrics for the wireless network links to determine an average speed of the wireless network links along the candidate network route, and (4) aggregating the average signal speed and the average speed to compute the second-metric route score for the candidate network route. By determining the second-metric route score using these operations, the mapping service determines a second-metric route score that considers both the signal strength and the speed of each wireless network links.

The signal strength and speed metrics are collected in some embodiments by sending an Application Programming Interface (API) request to a networking interface to request the signal strength and speed metrics, and receiving an API response from the networking interface comprising the requested signal strength and speed metrics. This networking interface in some embodiments maintains a cloud-based data store that stores various signal strength and speed metrics for various wireless network links at various locations. For instance, each wireless network link used in the vehicle is associated with a different carrier in some embodiments. In such embodiments, the mapping service retrieves metrics collected at different locations for those different carriers in order to score the wireless network links on their signal strength and speed.

In some embodiments, the first-metric route score for each candidate network route indicates how well the candidate network route's path compares to other candidate network routes' paths. The set of route navigation metrics in some embodiments includes metrics related to one or more of time duration of the candidate network route, speed along the candidate network route, traffic along the candidate network route, an amount of fuel to be used along the candidate network route, and a number of stops along the candidate network route. By computing a first-metric route score based on these route navigation metrics (i.e., route travel metrics), the mapping service quantifies the geographic performance of the candidate network routes.

The first-metric route score is computed in some embodiments by (1) determining a time duration for the candidate network route, and (2) normalizing the time duration to compute the first-metric route score. In order to compare each candidate network route based on its time duration, some embodiments normalize the value of the time durations into a scale (e.g., 1-10). In some embodiments, first-metric route scores are computed for the candidate network route by (1) determining a time duration for each candidate network route, (2) ordering the set of candidate network routes according to the determined time durations into an ordered set of candidate network routes, and (3) scoring each candidate network route based on its ordering in the ordered set of candidate network routes. By computing first-metric route scores using these operations, the mapping service scores short candidate network routes higher than longer candidate network routes.

In some embodiments, a first candidate network route that has a longer time duration than a second candidate network route has a lower first-metric route score than the second candidate network route. In such embodiments, a lower route score is a better route score. In other embodiments, a first candidate network route that has a shorter time duration than a second candidate network route has a higher first-metric route score than the second candidate network route because a higher route score is a better route score. First-metric route scores in other embodiments are determined by (1) determining a distance length for each candidate network route, (2) ordering the set of candidate network routes according to the determined distance lengths into an ordered set of candidate network routes, and (3) scoring each candidate network route based on its ordering in the ordered set of candidate network routes.

Before computing the first and second metric route scores, some embodiments receive, from a user of the vehicle through a UI, a request to provide optimal navigation instructions for the vehicle's travel from the first location to the second location. In some of these embodiments, the request is sent by the user using an API request. In other embodiments, the UI is a GUI, and the request is sent by the user using one or more selectable items in the GUI.

In some embodiments, for each candidate network route, the method aggregates the first and second metric route scores using a set of weights to compute an overall score for the candidate network route. In such embodiments, the method uses the one route to provide the navigation instructions based on the computed first and second metric route scores by selecting a particular candidate network route that has a best overall score as the one route. For instance, the user of the vehicle in some embodiments specifies weights for the first and second metric route scores such that the optimal score is influenced more by one of the scores than the other.

For example, a first weight is associated in some embodiments with the first-metric route score and a second, lower weight is associated with the second-metric route score. In such embodiments, the overall score is affected more by the first-metric route score than the second-metric route score. Alternatively, a first weight is associated in other embodiments with the first-metric route score and a second, higher weight is associated with the second-metric route score. In these embodiments, the overall score is affected more by the second-metric route score than the first-metric route score. This allows the user to receive a more custom optimal route to reach the second location.

In some embodiments, the navigation instructions provided for the vehicle's travel from the first to the second location include turn-by-turn instructions including at least one of visual output and audio output to a UI. In other embodiments, the navigation instructions only display the route navigated on a screen through the UI.

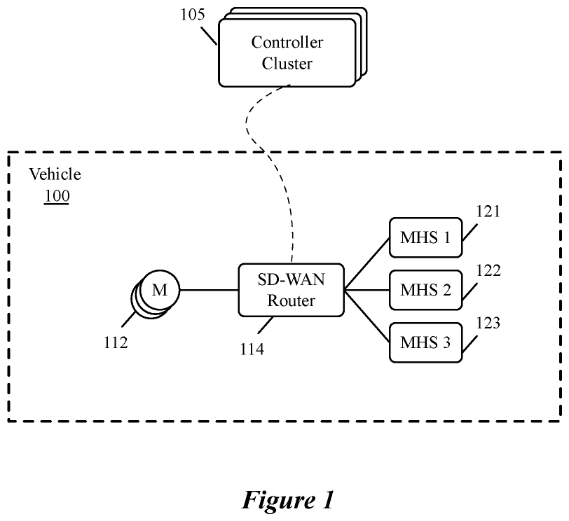

FIG. 1 illustrates an example of a vehicle 100 and a controller cluster 105 that implement the method of some embodiments of the invention. As shown, the vehicle 100 includes a set of one or more compute machines 112, an SD-WAN router 114 and several network links 121-123. The controller cluster 105 serves as a central point for managing (e.g., defining and modifying) configuration data that is provided to the components of the vehicle 100 to configure some or all of the operations. In some embodiments, this controller cluster 105 is in one or more public cloud datacenters, while in other embodiments it is in one or more private datacenters.

Examples of public cloud providers that provide public cloud datacenters include Amazon Web Services® (AWS), Google Cloud Platform™ (GCP), Microsoft Azure®, etc., while examples of entities include a company (e.g., corporation, partnership, etc.), an organization (e.g., a school, a non-profit, a government entity, etc.), etc. In some embodiments, the controller cluster 105 has a set of manager servers that define and modify the configuration data, and a set of controller servers that distribute the configuration data to the vehicle 100. In some embodiments, the controller cluster 105 directs the SD-WAN router 114 of the vehicle 100 to use certain gateways (i.e., assigns a gateway to the SD-WAN router 114).

The SD-WAN router 114 of some embodiments is one of an edge router appliance, an edge router executing on a computer that operates in the vehicle 100, or an edge router executing on a machine that executes on the computer. This machine may be one of a VM, a Pod, or a container. In some embodiments, the controller cluster 105 configures the SD-WAN router 114 to forward different data message flows (or data messages of a flow) along different telecommunication network links 121-123. The network links 121-123 are in some embodiments different mobile hotspot (MHS) links provided by different telecommunication network providers (e.g., AT&T, Verizon, T-Mobile, Orange, etc.). These network links 121-123 connect the vehicle 100 to an SD-WAN.

The controller cluster 105 of some embodiments configures the SD-WAN router 114 to forward data messages along different network links 121-123 such that the data messages are forwarded in an optimal configuration. In some embodiments, different wireless network links provide different transmission rates, different amounts of reliability, etc. In such embodiments, the controller 105 provides the SD-WAN router 114 with link selection rules for selecting links for forwarding data message flows. In other embodiments, the controller cluster 105 configures the SD-WAN router 114 to iteratively (1) collect metrics quantifying a set of attributes of each network link 1210123, and (2) select different network links 121-123 for forwarding data messages based on the collected metrics. These sets of attributes of the network links 121-123 quantified by the collected metrics may include attributes associated with at least one of reliability and speed of the network link 121-123. The network links 121-123 provide different levels reliability and transmission rates for data messages, and the reliability and speed of these links 121-123 can change based on the vehicle 100's location, the time of day, and other various factors. The set of attributes for each link 121-123, therefore, may include attributes relating to the link's reliability and speed, and the SD-WAN router 114 may forward data messages along the different network links 121-123 based on their reliability and speed. Any suitable performance or non-performance metrics associated with network links may be used to determine optimal links.

The controller cluster 105 of some embodiments configures the SD-WAN router 114 to iteratively (1) collect metrics quantifying a set of attributes of each network link 1210123 at different locations traveled by the vehicle 100, and (2) select different network links 121-123 for forwarding data messages at the different locations based on the collected metrics. As the vehicle 100 moves throughout different locations, the network links 121-123 will strengthen or weaken as the vehicle 100 moves closer to and farther away from different cellular towers. The SD-WAN router 114 may collect metrics for the network links 121-123 at various different locations to determine which links are optimal at the various locations, such that the SD-WAN router 114 can forward data messages using the optimal wireless network links when the vehicle is at each location. For instance, the SD-WAN router may use metrics for the network links 121-123 to determine that network link 121 is the optimal link at a first location, while network link 122 is the optimal link at a second location. Based on this determination, the SD-WAN router 114 forwards data messages using the first network link 121 when the vehicle 100 is at the first location, and forwards data messages using the second network link 122 when the vehicle 100 is at the second location. This ensures that data messages are forwarded using the optimal link, no matter the location of the vehicle 100.

The controller cluster 105 may also configure the SD-WAN router 114 to iteratively (1) collect metrics quantifying a set of attributes of each network link 121-123 at different times, and (2) select different network links for forwarding data messages at different times based on the collected metrics. In some embodiments, a network link may be optimal at one time of day, and not optimal at another time of day. In order to ensure that the optimal link is used, the SD-WAN router 114 uses the collected metrics to determine which network link 121-123 is optimal at each time of the day, and uses the optimal link at any given time throughout the day for forwarding data messages.

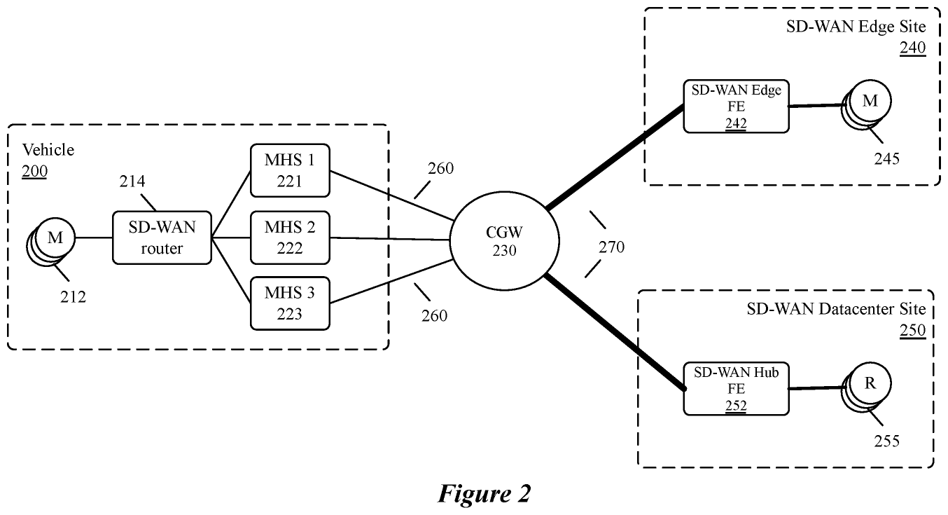

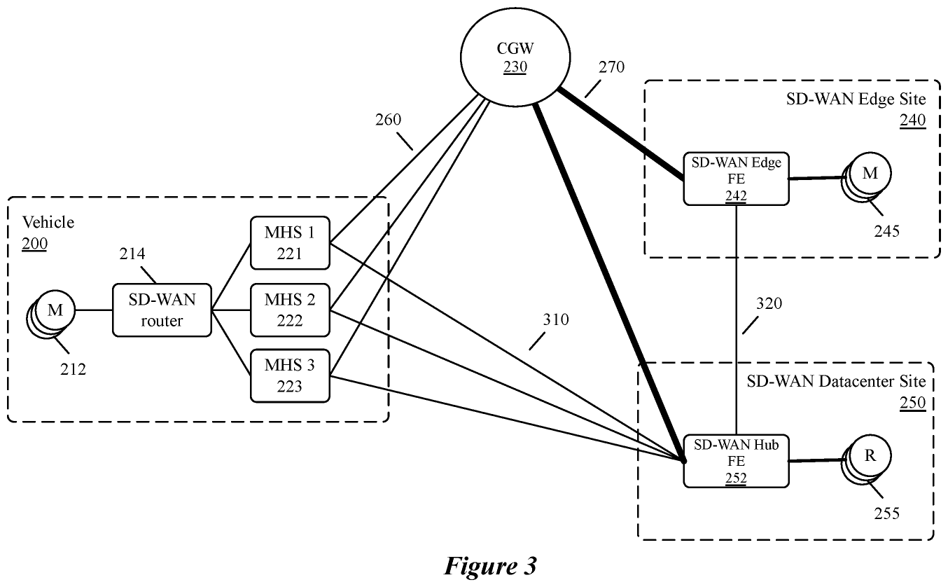

As discussed previously, an SD-WAN router of a vehicle uses the various network links to connect to an SD-WAN. FIGS. 2 and 3 illustrate an example vehicle 200 that communicates with various components of an SD-WAN, i.e., a cloud gateway (CGW) 230, an SD-WAN edge site 240, and an SD-WAN datacenter site 250. The vehicle 200 includes one or more compute machines 212, an SD-WAN router 214, and network links 221-223 for forwarding data messages to the various components of the SD-WAN. The edge site 240 is a branch site (e.g., of an entity that owns the vehicle 200 or is associated with the owner of this vehicle) that includes an SD-WAN forwarding element (FE) 242 and a set of one or more machines 245. The datacenter site 250 includes a hub forwarding node 252 and a set of one or more resources 255 which may be used by the edge site 240 or the vehicle 200. The datacenter SD-WAN forwarding node 252 is referred to as a hub node because in some embodiments this forwarding node can be used to connect to other edge forwarding nodes of the branch site 240 and of the vehicle 200. The hub node in some embodiments provides services (e.g., middlebox services) for packets that it forwards between a vehicle and a branch site. The hub node also provides access to the datacenter resources 255.

In some embodiments, each edge FE, hub FE, and CGW in an SD-WAN (such as the edge FE 0242, the datacenter hub forwarding node 0252, and the CGW 0230) includes a router that performs the data message forwarding operations of the edge FE, hub FE, or CGW. In such embodiments, the next-hop forwarding records of these edge FEs, hub FEs, and CGWs are routing records used by the routers to forward data messages through the SD-WAN. The edge FEs, hub FEs, and CGWs in some embodiments also include middleboxes.

The edge FE 0242 and the SD-WAN router 0214 in some embodiments connect to an external network through two or more forwarding devices (e.g., an MPLS (multiprotocol label switching) device, a cable modem router, a 5G router) of two or more communication service providers (e.g., a telephone company provider of an MPLS network, a cable modem provider of an ISP (Internet Service Provider), a wireless provider for the 5G connectivity). In some of these embodiments, each of the edge FE 0242 and the SD-WAN router 0214 connects to the forwarding devices of the service providers through two or more physical ports of the edge FE or SD-WAN router.

In the example of FIGS. 02 and 03, the hub 0252 is a multi-tenant forwarding element that is deployed on the premises of the datacenter 0250. The hub 0252 can be used to establish secure connection links (e.g., tunnels) with edge nodes at the particular entity's multi-computer sites such as the edge site 0240, edge routers in vehicles such as the vehicle 0200, third-party datacenters (not shown), etc. For example, the hub 0252 can be used to provide access from the vehicle 0200 to the edge site 0240 (e.g., via the connection links 0260 and 0270 that terminate at the hub 0252) as well as to the resources 0255 of the datacenter 0250. These multi-computer sites are often at different physical locations (e.g., different buildings, different cities, different states, etc.), according to some embodiments. In some embodiments, hubs can be deployed as physical nodes or virtual nodes. Additionally, hubs in some embodiments can be deployed on a cloud (e.g., as a set of virtual edges configured as a cluster).

In FIG. 2, the network links 221-223 of the vehicle 200 are shown to connect to the CGW 230 through connection links 260. In some embodiments, these connection links include secure and unsecure connection links, while in other embodiments they only include secure connection links. Multiple secure connection links (e.g., multiple secure tunnels that are established over multiple physical links) can be established between two components (e.g., a vehicle and a gateway, or an edge node and a gateway) in some embodiments.

The CGW 230 connects to the edge site 240 and the datacenter site 250 through secure connection links 270 that connect to the edge FE 242 of the edge site 240 and the hub FE 252 of the datacenter site 250. These connection links 270 are shown as bolded lines to represent the three telecommunication providers that provide the three network links 221-223 for the vehicle 200. In some embodiments, the edge site 240 and datacenter site 250 each include three separate forwarding elements for receiving communications with the vehicle 200 along the different network links 221-223. In other embodiments, only one forwarding element on each site communicates with the vehicle 200.

In some embodiments, the vehicle 200 connects directly to the edge site 240 and the datacenter site 250, without communicating through the CGW 230. FIG. 3 illustrates the same vehicle 200, CGW 230, edge site 240, and datacenter site 250, with secure connection links 310 connecting the network links 221-223 directly to the hub FE 252 of the datacenter site 250. Using these links 310, the vehicle 200 is able to access the edge site 240 and the datacenter site 250 without communicating through the gateway 230. This figure also illustrates a secure connection link 320 between the edge site 240 and the datacenter site 250. In some embodiments, the vehicle 200 accesses the edge site 240 through the datacenter site 250.

The hub FE 252 of the datacenter site 250 acts as a hub in order for the vehicle 200 to communicate with the edge FE 242 through the datacenter site 250. More specifically, in some embodiments, the hub 252 serves as the hub node of the SD-WAN in that it allows programs executing at an SD-WAN node (e.g., programs executing on the machines 212 operating in the vehicle) access to the datacenter resources 255 as well as access to the machines at the SD-WAN nodes (e.g., access to the machines 245 at the edge site 242). When providing access to another edge site's machines through that edge site's forwarding router (e.g., to machines 245 through the edge forwarding router 242), the hub serves as the hub node of an SD-WAN that is implemented in a hub-and-spoke architecture. In some embodiments, the SD-WAN performs middlebox services (e.g., firewall services, load balancing services, NAT services, etc.) to the SD-WAN traffic that passes through the hub. Lastly, in some embodiments, the cloud gateway 230 can direct the vehicle 200 to directly connect to the edge site 240 without passing its data messages first through the cloud gateway or the datacenter hub 252.

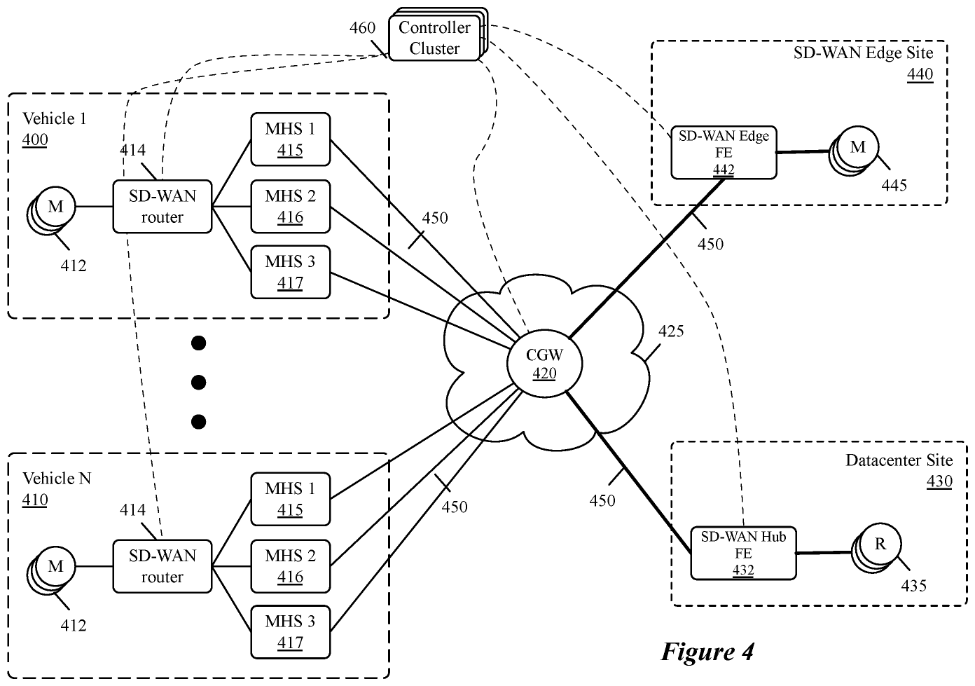

FIG. 4 illustrates an example of vehicles 400 and 410 that communicate with various components of an SD-WAN. Any number of vehicles 1-N may be used. The vehicles 400 and 410 respectively include sets of one or more compute machines 412, SD-WAN routers 414, and network links 415-417. The SD-WAN includes a cloud gateway 420, a datacenter site 430, and a branch site 440.

The CGW in some embodiments is a forwarding element that is in a private or public datacenter 425. The CGW 420 in some embodiments has secure connection links (e.g., tunnels) with edge forwarding elements (e.g., SD-WAN edge FE 442) at multi-machine sites (e.g., SD-WAN edge site 440 with multiple machines 445), such as branch offices, datacenters, etc. These multi-machine sites are often at different physical locations (e.g., different buildings, different cities, different states, etc.) and are referred to below as multi-machine sites or nodes. Two multi-machine sites 430 and 440 are illustrated in FIG. 4, with one of them being a branch site 440, and one being a datacenter site 430. The branch site is shown to include an edge forwarding node 442, while the datacenter site 430 is shown to include a hub forwarding node 432. The edge forwarding element (e.g., SD-WAN edge FE 442) exchanges data messages with one or more cloud gateways 420 through one or more connection links 450 (e.g., multiple connection links available at the edge forwarding element).

When multiple such links are defined between an edge node and a gateway, each secure connection link in some embodiments is associated with a different physical network link between the edge node and an external network. For instance, to access external networks, an edge node in some embodiments has one or more commercial broadband Internet links (e.g., a cable modem, a fiber optic link) to access the Internet, an MPLS link to access external networks through an MPLS provider's network, a wireless cellular link (e.g., a 5G LTE network). In some embodiments, the different physical links between the edge node 442 and the cloud gateway 420 are the same type of links (e.g., are different MPLS links).

In some embodiments, the edge forwarding node 442 can also have multiple direct links 450 (e.g., secure connection links established through multiple physical links) to a datacenter hub node 432. Again, the different links in some embodiments can use different types of physical links or the same type of physical links. Also, in some embodiments, the edge forwarding node 442 of the branch site can connect to a SD-WAN router of a vehicle (1) directly through one or more links 450, or (2) through a cloud gateway or datacenter hub to which the edge forwarding node connects through two or more links 450. Hence, in some embodiments, the edge forwarding node 442 of the branch site 440 can use multiple SD-WAN links 450 to reach an SD-WAN router (e.g., 204) of a vehicle (e.g., 400), or a hub forwarding node 432 of a datacenter site 430.

The cloud gateway 420 in some embodiments is used to connect an SD-WAN router of a vehicle (e.g., SD-WAN router 414 of vehicle 410) to an SD-WAN forwarding node (e.g., edge forwarding element 442) through at least two secure connection links 450 between the gateway 420 and the SD-WAN router and between the gateway 420 and the forwarding element at the SD-WAN site (e.g., branch site 440 or datacenter site 430). In some embodiments, the cloud gateway 420 also provides network data from a vehicle to a multi-machine site or from one multi-machine site to another multi-machine site (e.g., provides the accessible subnets of one site to another site). Like the cloud gateway 420, the hub forwarding element 432 of the datacenter 430 in some embodiments can be used to connect an SD-WAN forwarding node 442 of a branch site to an SD-WAN router of a vehicle through at least two secure connection links 450 between the hub 432 and the SD-WAN router and between the hub 432 and the forwarding element at the branch site 440.

In some embodiments, each secure connection link between two SD-WAN forwarding nodes (i.e., CGW 420 and edge forwarding node 442) is formed as a VPN (virtual private network) tunnel between the two forwarding nodes. In this example, the collection of the SD-WAN forwarding nodes (e.g., forwarding element 442 and gateways 420) and the secure connections 450 between the forwarding nodes forms a virtual network for a particular entity that spans at least public or private cloud datacenter 425 to connect the branch and datacenter sites 430 and 440.

In some embodiments, secure connection links are defined between gateways in different public cloud datacenters to allow paths through the virtual network to traverse from one public cloud datacenter to another, while no such links are defined in other embodiments. Also, in some embodiments, the gateway 420 is a multi-tenant gateway that is used to define other virtual networks for other entities (e.g., other companies, organizations, etc.). Some such embodiments use tenant identifiers to create tunnels between a gateway and edge forwarding element of a particular entity, and then use tunnel identifiers of the created tunnels to allow the gateway to differentiate data message flows that it receives from edge forwarding elements of one entity from data message flows that it receives along other tunnels of other entities. In other embodiments, gateways are single-tenant and are specifically deployed to be used by just one entity.

FIG. 4 illustrates a cluster of controllers 460 that serves as a central point for managing (e.g., defining and modifying) configuration data that is provided to the edge nodes and/or gateways to configure some or all of the operations. In some embodiments, this controller cluster 460 is in one or more public cloud datacenters, while in other embodiments it is in one or more private datacenters. In some embodiments, the controller cluster 460 has a set of manager servers that define and modify the configuration data, and a set of controller servers that distribute the configuration data to the edge FEs, hubs and/or gateways. In some embodiments, the controller cluster 460 directs edge forwarding elements and hubs to use certain gateways (i.e., assigns a gateway to the edge forwarding elements and hubs). The controller cluster 460 also provides next hop forwarding rules and load balancing criteria in some embodiments.

To connect the vehicles 400 and 410 to the cloud gateway 420, datacenter site 430, and branch site 440, the SD-WAN routers 414 use the network links 415-417. As discussed previously, a controller cluster 460 configures an SD-WAN router to iteratively (1) collect metrics quantifying a set of attributes of each network link in the vehicle, and (2) select different network links for forwarding data messages to components of the SD-WAN based on the collected metrics. In some embodiments, the controller cluster 460 configures an SD-WAN router (e.g., 414) to embed data messages with a sequence number for a destination router of the SD-WAN that receives the data messages. Further information regarding re-sequencing will be described below.

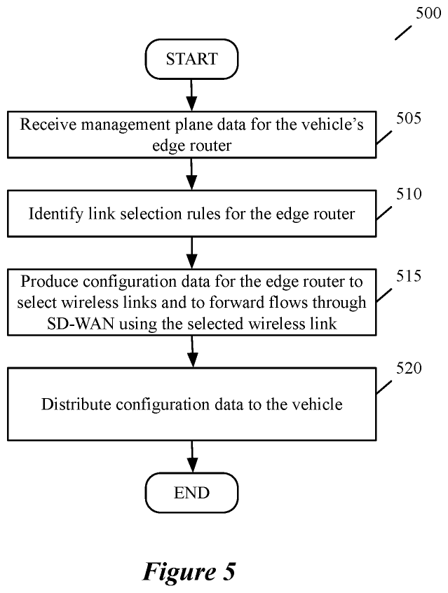

FIG. 5 conceptually illustrates a process 500 used by a controller cluster 460 to configure the SD-WAN edge router (e.g., routers 214 or 414) of a vehicle. The process 500 when the controller cluster receives (at 505) input from a management plane (MP) interface, and generated configuration data based on this input. This input can come from a MP program or from an administrator of the network that interfaces with the management plane. The vehicle edge router in some embodiments is one of an edge router appliance, an edge router executing on a computer that operates in the vehicle, or an edge router executing on a machine (e.g., a VM, a Pod, or a container) that executes on the computer.

Next, at 510, the process 500 identifies a set of one or more link selection rules for the edge router of the vehicle. The link selection rules may be provided directly from a user or administrator, or the controller set may receive data from the user for the controller to generate the link selection rules. As further discussed below, the vehicle's edge router in some embodiments selects links for forwarding different flows or different data messages of a flow in order to forward data messages in an optimal configuration.

The identified set of link-selection rules in some embodiments includes a rule specifying selecting a wireless network link with a highest reliability score for a particular type of traffic (e.g., for a critical type of traffic). When forwarding a flow of this traffic type, the edge router may compute reliability scores for each of the wireless network links (e.g., using collected metrics quantifying attributes of the links) and, using the rule, select the link with the highest reliability score to use to forward the critical flow.

In some cases, the link with the highest reliability score might not have the highest transmission rate score, meaning that the most reliable link might not be the fastest. In such cases, a critical flow might not be sent along the fastest link or the link with the highest throughput, but is instead sent along the most reliable link, as specified by the rule in the rule set. The set of rules in some embodiments includes a rule specifying selecting a the fastest wireless network link that meets a threshold reliability score for a particular type of traffic. In some such embodiments, two or more wireless network links may have pre-requisite threshold reliability scores, and in such a case, the edge router would then select the network link that has the faster speed.

In some embodiments, the set of rules includes a rule that specifies selecting a wireless network link with a lowest transmission time score for a particular type of traffic. As discussed previously, a particular type of traffic may require being sent along the fastest wireless network link. When forwarding a flow of this traffic type, the edge router may compute transmission time scores for each of the wireless network links (e.g., using collected metrics quantifying attributes of the links) and, using the rule, select the link with the lowest transmission time score (equating to the fastest link) to use to forward the flow.

Next, the process 500 produces (at 515) configuration data for configuring the edge router to perform link selection processes based on the link selection rules for forwarding data messages along links of the vehicle, and to forward flows through the selected links. For different flows, the configuration data can configure the edge router to perform differently, e.g., to select links with different metrics and/or to select one or more links.

The process 500 then distributes (at 520) the produced configuration data to the vehicle's edge router to use to select links for the different flows and forward the flows through the selected links. In some embodiments, the configuration data configures the edge router to forward flows from a device operating in the vehicle (e.g., a computer located in the vehicle or a machine (e.g., virtual machine, Pod, container, etc.) executing on a computer located in the vehicle) to the SD-WAN. The configuration data in some embodiments configures the edge router to use its link selections to forward flows in the most optimal configuration. For instance, the controller may provide a link selection rule to the edge router specifying that a particular flow must be sent along the most reliable link.

The configuration data also configures the vehicle's edge router to connect to wireless network links in the vehicle. The configuration data also includes next-hop forwarding rules in some embodiments that direct the vehicle's edge router to forward flows to a cloud gateway, a datacenter hub (e.g., to access resources of the datacenter) and/or a branch site's edge router (e.g., to send data messages to an edge node of the branch site). After distributing the configuration data to the vehicle, the process ends.

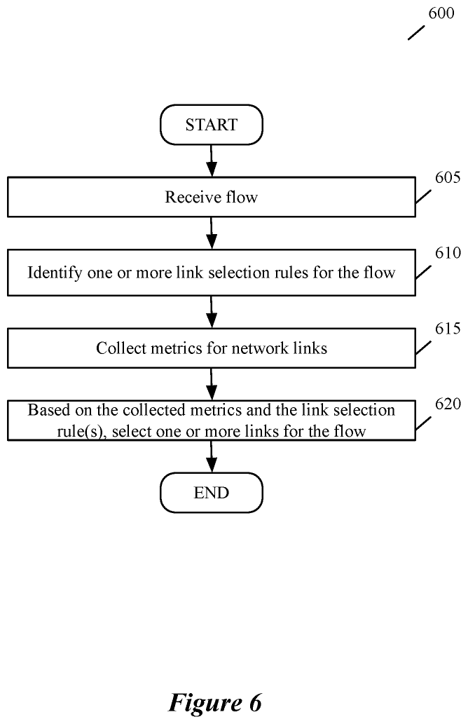

FIG. 6 conceptually illustrates a process 600 that the vehicle's edge router (e.g., SD-WAN router 114, 214 and 414) performs in some embodiments to select one or more links for a flow and to forward data messages of the flow along the selected link(s). The process 600 begins when the edge router receives (at 605) the first data message (e.g., the first packet) of the flow. This flow may be received from a machine (e.g., a VM) executing on a computer operating on the vehicle, and may be sent to a destination machine in a datacenter or branch site connected to the SD-WAN.

At 610, the process 600 identifies one or more link selection rules for the flow. In some embodiments, the edge router receives link selection rules from the controller cluster and stores them in a local database. In some embodiments, the process selects the link selection rule(s) by matching the received flow's attributes (e.g., its five tuple attributes, and/or dynamically identified attributes, such as its AppID that identifies the type of traffic carried in the flow's payload) with the match attributes of the link selection rules that it stores in its local database. In such embodiments, each link selection rule is associated with a set of match criteria, which includes an AppID and other parameters (e.g., five-tuple) in some embodiments. To identify one or more link selection rules, the edge router matches the received flow's AppID (and conjunctively, or alternatively, other parameters) to the AppID specified in the match criteria of the link selection rule.

Conjunctively or alternatively, the in-vehicle hypervisor identifies the application type associated with the received flow by associating metadata with the source machine (e.g., its source VM) in the form of VM tags stored as part of the VM's definition. These tags in some embodiments indicate the application class running in the VM. Through an integration between the edge router and the hypervisor, the IP address of the VM is identified in some embodiments to the edge router along with the tag metadata, such that all traffic from the identified IP address can be handled in a manner stipulated by the QoS policies associated with the VM tag metadata. In other embodiments, the edge router identifies the link selection rule using deep packet inspection (DPI) (e.g., using a DPI engine of the edge router). Each link-selection rule either identifies a wireless link specifically or specifies one or more criteria for the edge router to use to select one or more wireless links for the flow.

Next, at 615, the process 600 collects metrics for the network links operating in the vehicle. In some embodiments, an identified link selection rule specifies that the particular flow must be sent along a link that is associated with certain metrics. For example, the link selection rule may specify that the particular flow must be sent along the fastest wireless network link, and the edge router must then collect metrics for each link to determine which link is fastest. One or more processes executing on the vehicle's computer continuously collect metrics for each wireless link of the vehicle, and store these metrics in a local database stored on the same or another computer operating on the vehicle. In some embodiments, the metrics are collected from the controller set that configures the edge router. Conjunctively, or alternatively, the metrics are collected from a server or another vehicle that generated the metrics and/or are collected by the edge router by performing metrics generation processes on the links, as described further below.

Based on the identified link-selection rule(s) and the collected metric, the process 600 selects (at 620) one or more links for forwarding the flow through the SD-WAN to its destination. For instance, the flow's matching link-selection rule might specify that the most reliable wireless link should be used for the flow, and based on this rule, the process 600 selects the wireless link with the most reliable metric score.

In some embodiments, the edge router identifies multiple link selection rules for the flow, specifying using different links for different data messages in the flow for optimal link configuration. In such embodiments, the edge router selects different links for different data messages in the received flow. After selecting one or more links for forwarding the flow, the edge router uses the selected link(s) to forward the data messages of the flow to its destination along the selected link(s). After selecting one or more links for the flow, the process 600 ends.

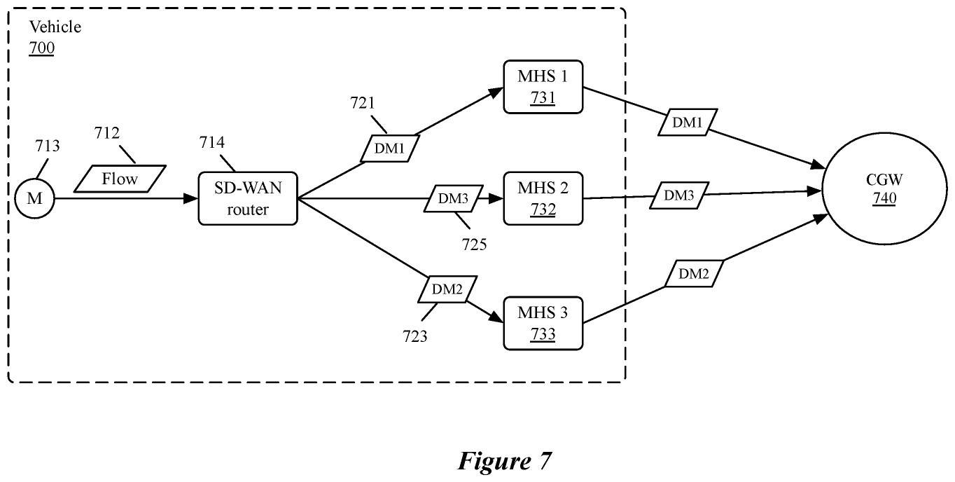

FIG. 7 illustrates an example flow 712 being sent from a machine 713 operating on a vehicle 700 to a cloud gateway 740 of an SD-WAN. The flow 712 is received by the SD-WAN router 714 for the router to forward different data messages of the flow 712 along different links. Using link selection processes, such as the process 600 of FIG. 6, the SD-WAN router 714 forwards the flow's first set of data message 721 along the first network link 731 to the CGW 740, the flow's second set of data messages 723 along the third network link 733 to the CGW 740, and the flow's third set of data messages along the second network link 732 to the CGW 740.

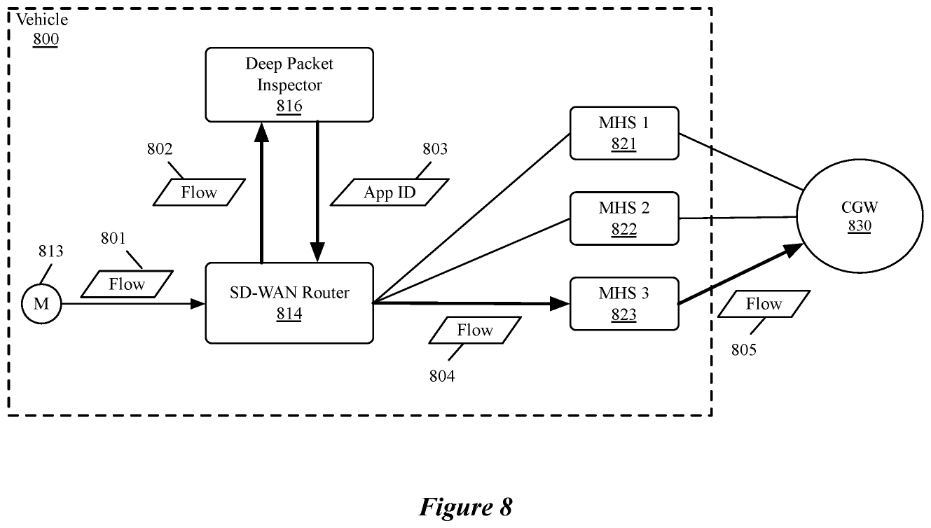

In some embodiments, an edge router of a vehicle uses DPI to forward flows from the vehicle to a destination in an SD-WAN. FIG. 8 illustrates an example vehicle 800 that includes an SD-WAN router 814, a deep packet inspector 816, and wireless network links 821-823 to connect to a cloud gateway 830 of an SD-WAN. In this example, a particular flow is received (at 801) by the SD-WAN router 814 from a machine 813 executing on the vehicle 800. After receiving the flow, the SD-WAN router 814 sends the flow to the deep packet inspector 816 at 802. The deep packet inspector 816 receives the flow and performed DPI on the flow to return an application identifier (App ID) for the flow. This App ID identifies the application that is the source of the flow.

The deep packet inspector 816 then sends the App ID to the SD-WAN router 814 at 803 so the SD-WAN router 814 can select a network link for forwarding the flow to the cloud gateway 830. In some embodiments, the SD-WAN router 814 performs a link selection process similar to the process 600 of FIG. 6 by using the App ID of the flow to identify a link selection rule associated with that App ID. Once a link is selected, the SD-WAN router 814 forwards the flow along the selected link at 804 and to the cloud gateway 830 at 805. In this example, network link 823 has been selected for forwarding the flow.

In some embodiments, the SD-WAN router 814 uses the deep packet inspector 816 to perform DPI on a particular flow to identify a type of traffic carried by data messages of the particular flow. Once the App ID is received from the deep packet inspector 816, the SD-WAN router 814 can determine the type of traffic of the flow and select, based on the identified traffic type, a particular wireless network link from the several wireless network links to forward the particular flow. The type of traffic may be a critical type of traffic that requires a highly reliable wireless network link, a type of traffic that requires a fast wireless network link, or some other type of traffic that only a particular wireless network link can forward such that it satisfies the requirement(s) of that type. For example, based on the App ID from the deep packet inspector 816, the SD-WAN router 814 can determine that this flow is a critical flow. Once the flow is determined to include critical traffic, the SD-WAN router 814 can select a network link that is the most reliable. Reliability can be determined based on generated metrics for the various links 821-823. Once the most reliable link is determined, the SD-WAN router 814 can forward the critical flow along the most reliable link.

As discussed previously, an edge router can forward data messages of a flow along different wireless network links to a destination. In some embodiments, the edge router forwards the data messages to a destination router for the gateway to forward to a subsequent destination. For instance, an edge router may forward data messages (e.g., Ethernet packets, Layer 2 packets) of one flow along three separate network links to a gateway, and the gateway will forward the data messages to a destination edge node of a branch site. In some embodiments, because the data messages can be sent along different wireless network links, the data messages may not be received at the destination router in the same order in which they were sent. In such embodiments, the edge router may embed the data messages with a sequence number in order for the destination router to determine the correct order of the data messages and send them in the correct order. In some embodiments, the sequence numbers are embedded in a header of each data message. In other embodiments, the sequence numbers are embedded in a payload of each data message.

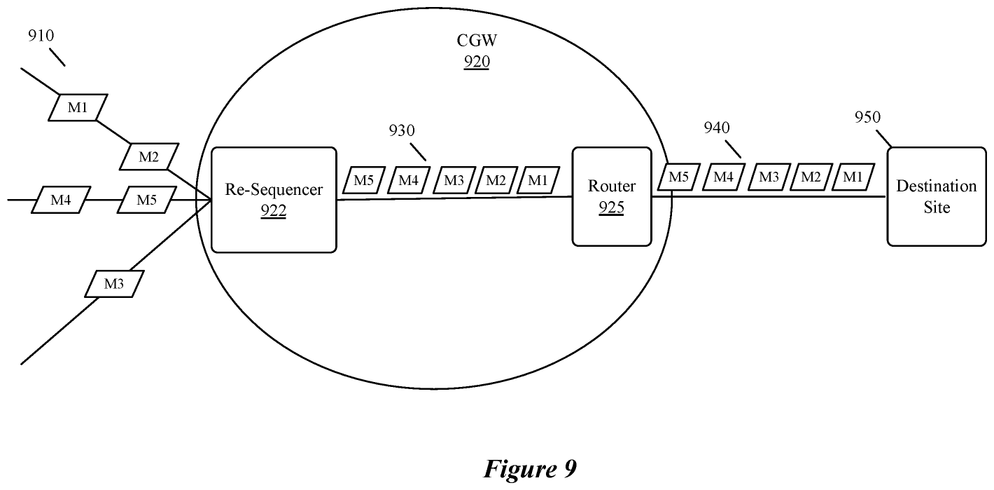

FIG. 9 illustrates an example of a flow that includes five data messages 910 being sent along three wireless network links to a cloud gateway 920. These data messages 910 are embedded with sequence numbers. The data messages 910 are received at a re-sequencer 922 of the gateway 920. The re-sequencer 922 uses the embedded sequence numbers to put the data messages in their correct sequential order, regardless of whether the re-sequencer 922 received them in that correct sequential order or not. In some embodiments, the re-sequencer 922 leaves the sequence numbers embedded into the data messages. In other embodiments, the re-sequencer 922 removes the sequence numbers from the data messages.

Once in their correct order, the re-sequencer 922 sends the data messages in the correct sequential order 930 to a router 925 of the gateway 920, for the router 940 to forward the data messages in the correct sequential order to their subsequent destination 950 in the SD-WAN. In this example, the data messages are being sent from the router 925 along different network links, shown as data messages 940. In other embodiments, however, the router 925 may forward the data messages in their correct order along a single network link to the subsequent destination. By embedding sequence numbers and re-sequencing the data messages at the destination router, it ensures that data messages are optimally sent to the destination router by being sent along different wireless network links, and that the data messages are sent in the correct order to their subsequent destination.

As discussed previously, an edge router of a vehicle may generate metrics associated with different wireless network links in order to select optimal links for forwarding data messages. For instance, an edge router may iteratively (1) collect metrics quantifying a set of attributes of each network link at different times, and (2) select different network links for forwarding data messages at different times based on the collected metrics. In some embodiments, a network link may be optimal at one time of day, and not optimal at another time of day. In order to ensure that the optimal link is used, the edge router uses the collected metrics to determine which network link is optimal at each time of the day, and uses the optimal link at any given time throughout the day for forwarding data messages.

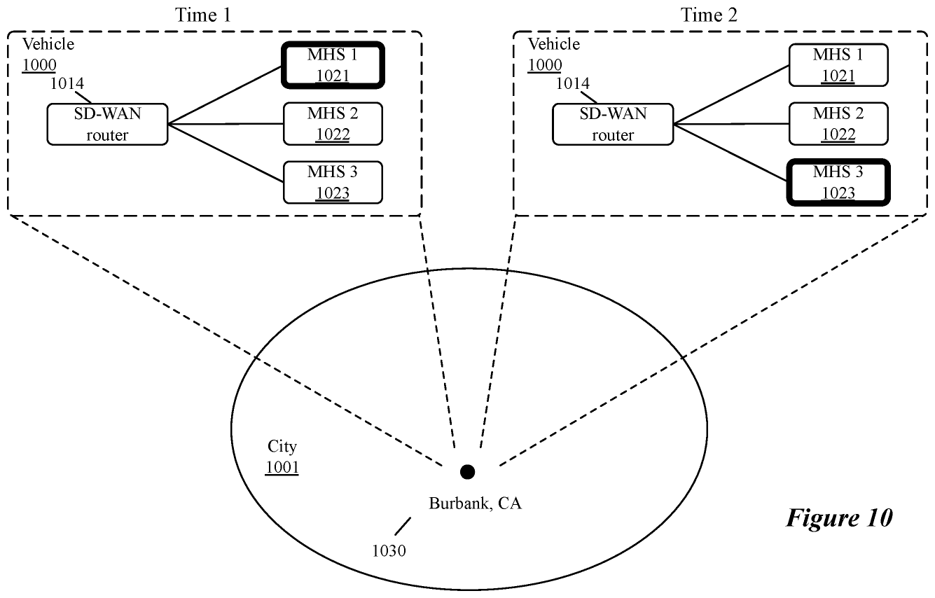

FIG. 10 present an example that illustrates selection of two different links of a stationary vehicle 1000 at two different times. The vehicle 1000 includes an SD-WAN router 1014 and network links 1021-1023 for forwarding data messages to SD-WAN destinations outside of the vehicle 1000. At both times, the vehicle is at the same location 1030 in a city 1001. In this figure, the SD-WAN router 1014 collects metrics to identify the wireless network link that is optimal to use at different times in the day.

At Time 1, the SD-WAN router 1014 has selected network link 1021 for forwarding data message flows, as shown by a bolded line. At Time 2, the SD-WAN router 1014 has selected network link 1023 for forwarding data message flows, as shown by a bolded line. In some embodiments, these different selections of links at different times in the same location may be due to differing signal strength of the network links at different times of the day. For example, network link 1021 may has the strongest signal strength at Time 1, while network link 1023 has the strongest signal strength at Time 2. Alternatively, the selection of the different links might be due to different congestion levels of the different links at different times in the day. Any metrics associated with the network links 1021-1023 may affect which link is optimal at either of the time instances, resulting in different link selections. In this example, only one link is selected at any given time, but it should be noted that in some embodiments, two or more links may be concurrently selected at any given time for a particular flow.

In some embodiments, the edge router may iteratively (1) collect metrics quantifying a set of attributes of each network link at different locations traveled by the vehicle, and (2) select different network links for forwarding data messages at the different locations based on the collected metrics. As the vehicle moves throughout different locations, the network links will strengthen or weaken as the vehicle moves closer to and farther away from different cellular towers. The edge router may collect metrics for the network links at various different locations to determine which links are optimal at the various locations, such that the edge router can forward data messages using the optimal wireless network links when the vehicle is at each location.

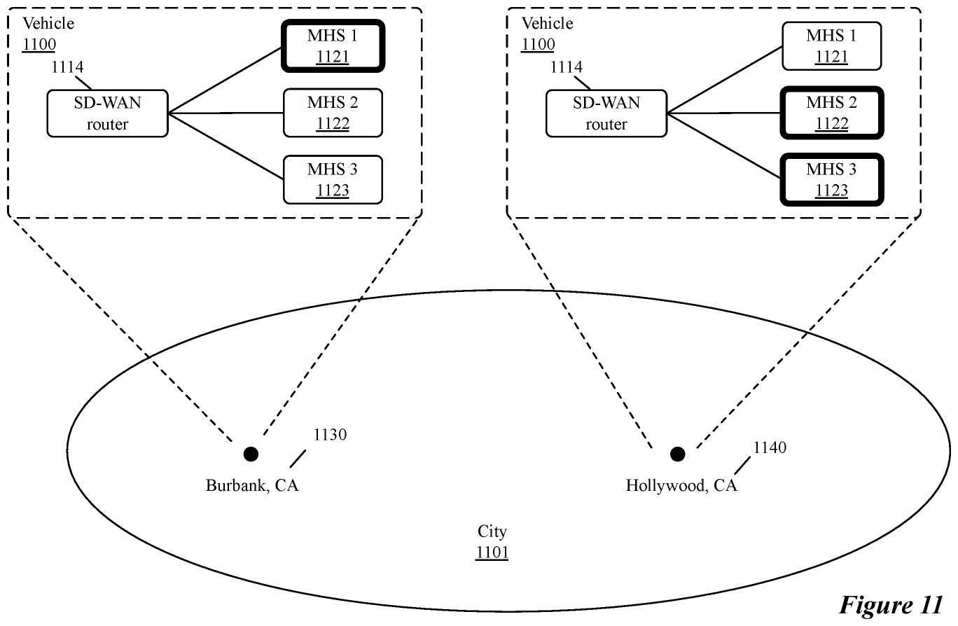

FIG. 11 present an example that illustrates selection of two different links of a moving vehicle 1100 at two different locations in a city 1101. The vehicle 1100 includes an SD-WAN router 1114 and three network links 1121-1123. In this figure, the SD-WAN router 1114 collects metrics associated with the network links 1121-1123 to determine which links are optimal at different physical locations of the vehicle.

At a first location 1130, the SD-WAN router 1114 has selected network link 1121 for forwarding data message flows, as shown by a bolded line. At a second location 1140, the SD-WAN router 1114 has selected two network links 1122 and 1123 for forwarding data messages. In some embodiments, only one link is selected for each location of the vehicle. In other embodiments, as in this example, multiple links may be selected, e.g., based on a metric of the links meeting a minimum threshold. For example, for links selected based on signal strength, the SD-WAN router 1114 may select all links that meet or exceed a minimum signal strength, and only links not meeting that minimum signal strength are not used.

In some embodiments, distinct locations are defined such that a link selection process is performed at each of those distinct locations. For instance, a fixed distance may be defined such that for every “X” distance the vehicle travels, the edge router of the vehicle performs a link selection process to determine which link or links to use at that location of the vehicle. For example, the edge router may be configured to select new links every 1/10^{th} of a mile that the vehicle travels. In other embodiments, different location points may be defined such that when the vehicle reaches each specified location, the link selection process is performed.

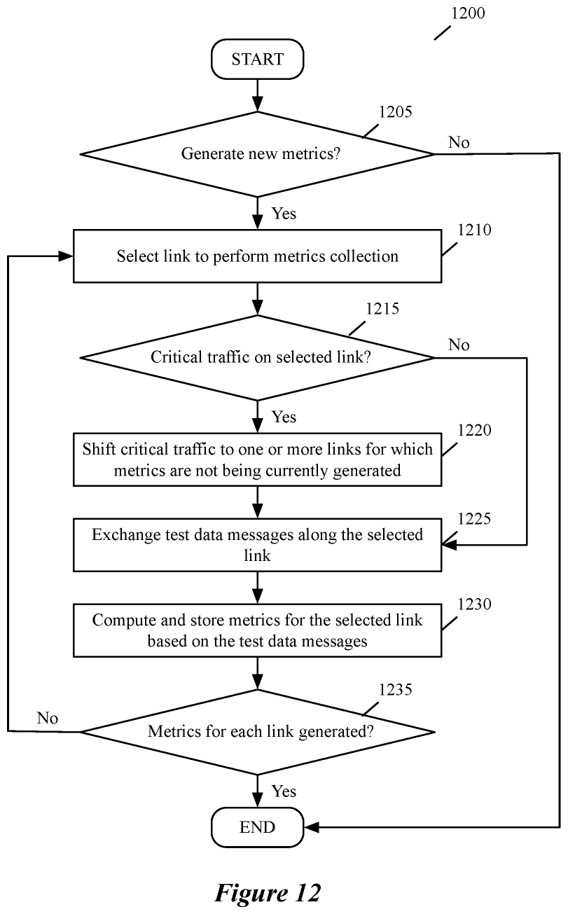

FIG. 12 conceptually illustrates a process 1200 of some embodiments for generating metrics associated with network links. This process may be performed by an edge router of a vehicle or a metric collector that executes along with the edge router on the vehicle. In some embodiments, this process is performed to determine the available bandwidth of each link at a particular location so that the edge router can select the optimal link or links at this location based on their available bandwidth.

The process 1200 begins by determining (at 1205) whether to generate new metrics for each link used to forward data messages from the vehicle to one or more destinations. The edge router may determine this based on the time of day if the edge router is configured to generate new metrics periodically. The edge router may also determine this based on the location of the vehicle. For instance, as the vehicle moves, the metrics generated for each link may change (e.g., as the links change distances from different cellular towers). Hence, the edge router can perform this process 1200 periodically when the vehicle is at different locations. In some embodiments, a fixed distance (e.g., specified by a user or administrator) is used to determine when the process 1200 is performed, such that the process 1200 is performed a first time at a first location, and then a second time at a second location that is the fixed distance away from the first location. These two locations in some embodiments are determined based on global positioning system (GPS) location data provided by a GPS satellite. The two locations of the vehicle in other embodiments are determined based on cellular derived location data.

If the process 1200 determines that new metrics are not to be generated, the process 1200 ends. If the process 1200 determines that new metrics are to be generated, the process 1200 selects (at 1210) a link to perform metrics collection. In some embodiments, the edge router generates metrics for each link one at a time. After selecting a link, the process 1200 determines (at 1215) whether any critical traffic (i.e., critical data messages) is currently being forwarded along the selected link. To facilitate metrics generation without compromising critical traffic that requires high reliability, such traffic should be first shifted to alternate available links. For example, if three carriers on three cellular links are available to the edge router, a first link would entail removal of critical traffic from this link and redistribution of this traffic across one or more of the other links during the brief period of time the metrics generation is performed for the first link.

If the process 1200 determines that critical traffic is being sent along the selected wireless network link, the process 1200 shifts (at 1220) the critical data messages to be forwarded over one or more of the other links for which metrics are not being currently generated. If no other links meet the requirements of the critical traffic, the metrics collection process is in some embodiments paused and re-attempted at a subsequent time in the near future. Once metrics for the selected link is finished, the edge router may shift the critical data messages back over to this link while metrics generation is performed for the other links. If the process 1200 determines that critical traffic is not being sent along the selected link, the process 1200 proceeds to 1225. At 1225, the process 1200 exchanges test data messages with a destination router of the SD-WAN along the selected link. The edge router exchanges these test data messages with the destination router (e.g., a gateway or an edge node) in order to gather information about the selected network link. Exchanging test data messages along the selected network link includes exchanging a minimal quantity of data in order to minimize the adverse effect of ongoing SD-WAN transmissions.

After the test data messages have been exchanged, the process 1200 computes and stores (at 1230) metrics for the selected link based on the test data messages. In the example of calculating available bandwidth of the links, the edge router determines a transmission duration for each test data message exchanged along the selected link. Based on the transmission durations for each test data message, the edge router determines a transmission rate of the selected link. Based on the transmission rate, the edge router determines the available bandwidth for the selected link.

Then, the process 1200 determines (at 1235) whether metrics have been generated for each of the network links connected to the edge router. The edge router in some embodiments determines whether metrics have been generated for each network link in order to ensure that each network link is associated with its own set of metrics. If the process 1200 determines that metrics have not been generated for all links (i.e., that metrics have not yet been generated for at least one network link), the process 1200 returns to 1210 to select a new link to perform metrics collection. If the process 1200 determines that metrics have been generated for all network links, the process 1200 ends.

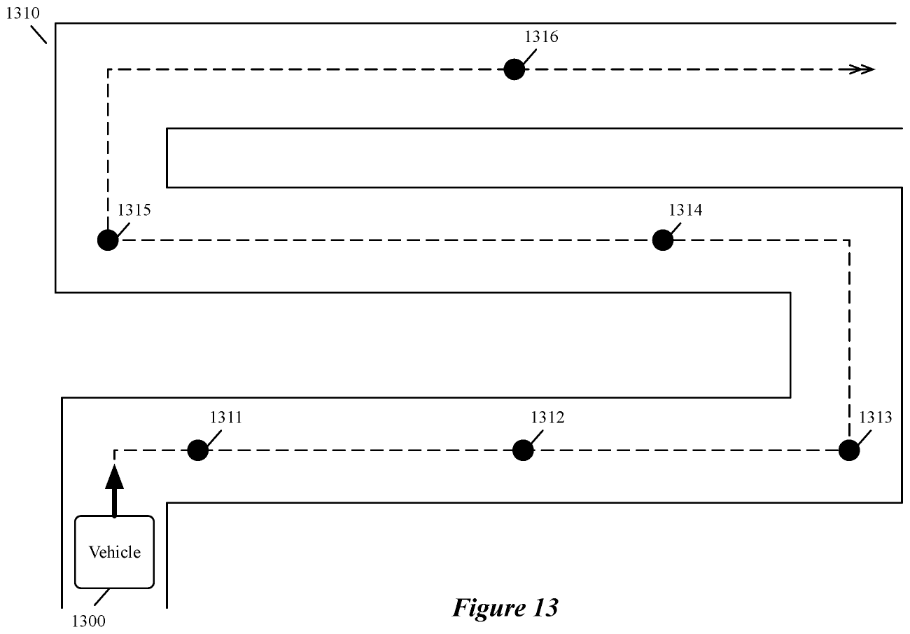

In some embodiments, a vehicle proactively selects links to use at different locations along a route before it reaches these locations. FIG. 13 illustrates an example vehicle 1300 travelling along a route 1310. Before reaching any of these locations, the vehicle's SD-WAN router identifies six possible locations 1311-1316 where this router should select another wireless link for one or more flows that it might forward through the SD-WAN. To do this, the vehicle's SD-WAN router in some embodiments uses metrics that it has previously collected for these locations, and/or metrics for these locations that it collects in real time from one or more servers (e.g., the controller cluster or another server cluster) or one or more vehicles that are concurrently operating in the field.

In some embodiments, the SD-WAN router of the vehicle 1300 as it reaches each location 1311 to 1316 changes its selected wireless network link for one or more flows at this location, in order to more seamlessly transition between the network links. Alternatively, in other embodiments, the SD-WAN router uses the links that it identifies for each location 1311-1316 as an initial wireless link candidate for that location. In such embodiments, the SD-WAN router foregoes using the candidate wireless link for a location if the collected metrics at the location demonstrate that the candidate link is no longer the best link for a set of flows for which it was identified previously as an optimal wireless link.

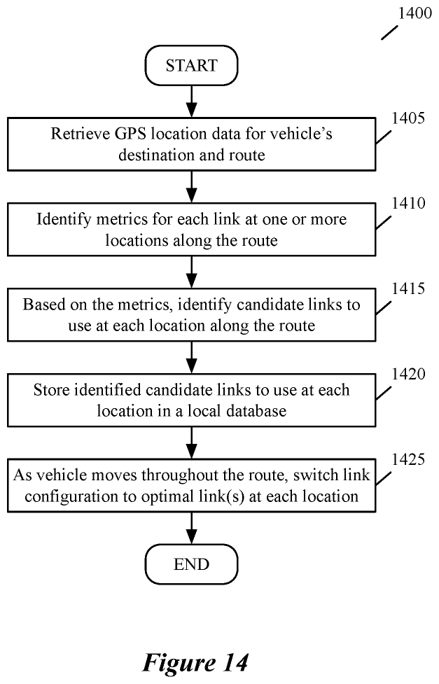

FIG. 14 conceptually illustrates a process 1400 for proactively selecting links along various locations of a future route of the vehicle. This process 1400 may be performed by an edge router of the vehicle. The process 1400 begins by retrieving (at 1405) GPS location data for the vehicle's destination and the route. The edge router retrieves this data in order to plan the route that the vehicle will take and plan which links to use along the route. The GPS location data may be retrieved from a GPS satellite, a server, another vehicle, or any suitable source.

Next, at 1410, the process 1400 identifies metrics for each link at one or more locations along the route. In some embodiments, these locations are defined by where the retrieved metrics were collected or generated. In other embodiments, the locations are defined by the edge router based on a configuration of the edge router. For example, the edge router may be configured to define these locations along the route based on a fixed distance such that a location is defined along every “X” distance along the route. the edge router may instead be configured to define the locations based on location definition data received from a user or administrator, specifying specific locations for which the edge router should select new links. In such embodiments, the edge router uses the received location definition data to determine one or more locations on the vehicle's route.

In some embodiments, the edge router retrieves the link metrics by computing a metrics generation process, such as the process 1200 of FIG. 12. These retrieved metrics may also be historical (i.e., previously generated or collected) metrics (1) stored in and retrieved from a local database in the vehicle, (2) retrieved from one or more servers, and/or (3) retrieved from one or more other vehicles concurrently in the field with the vehicle and/or previously in the field. The retrieved metrics in some embodiments are validated by the vehicle by running tests as the vehicle travels along a route. For instance, if the vehicle retrieves location based link metrics from another vehicle, the edge router of the vehicle may perform methods and processes to validate these metrics as the vehicle reaches the locations at which the metrics were collected.

Based on the retrieved metrics, the process 1400 identifies (at 1415) candidate links to use at each location along the route. The edge router determines optimal links for each defined location along the vehicle's route in order for the vehicle to predict which links are optimal along the route. The process 1400 then stores (at 1420) the identified candidate links to use at each location in a local database. The edge router stores the candidate link selections in a local database so the edge router can identify the candidate links as the vehicle reaches the various locations along the route.

As the vehicle moves throughout the route, the process 1400 switches (at 1425) the vehicle's link configuration to optimal link(s) at each location along the route. In some embodiments, the edge router always selects the candidate links at the various locations along the route. In other embodiments, the edge router may select the candidate links along the route, or may not select them. In such embodiments, the edge router may also generate new metrics for each location and determine a new link selection at the location. If the new link selection is different than the predicted candidate link selection, the edge router can use the new link selection. After 1425, the process 1400 ends.

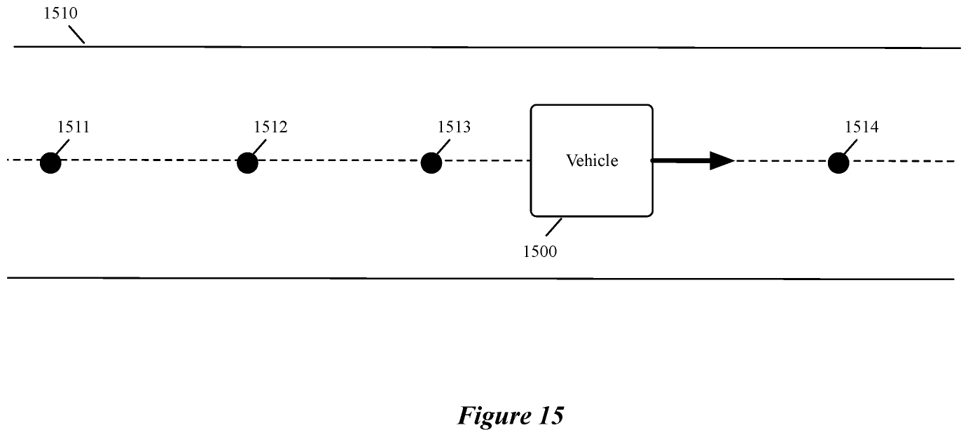

FIG. 15 illustrates an example vehicle 1500 travelling along a straight route 1510. The vehicle 1500 has collected metrics 1511-1513 for links at previous locations of the vehicle, but has not yet collected any metrics or selected any links at a future location 1514. In order to predict which link or links to use at this future location 1514, the vehicle 1500 of some embodiments uses a predictive modeling method using metrics taken at previous locations 1511-1513. In this example, the vehicle 1500 is travelling in a straight line, so the vehicle 1511 is able to use a simple distance scheme for predicting future location metrics. For instance, the vehicle 1300 is able to determine a one-dimensional distance between itself and each of the past locations 1511-1513 and the future location 1514. In other embodiments, a vehicle does not travel along a straight line. In such embodiments, the vehicle can utilize trigonometric functions to more accurately estimate the predicted link selection at future locations, based on the vehicle's direction, speed, and the estimate future location in relation to each link's previous metrics.

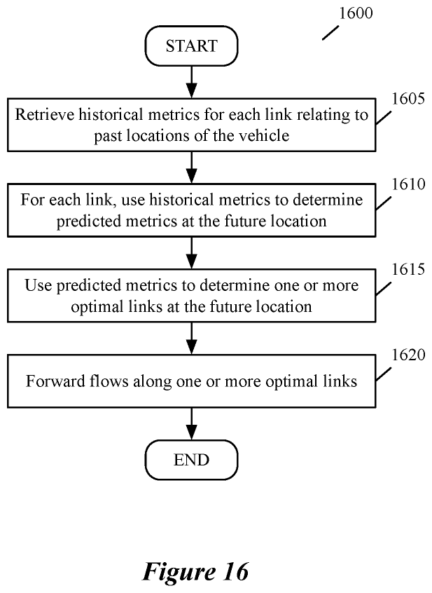

FIG. 16 conceptually illustrates a process 1600 of some embodiments for distributing data message flows across multiple network links for forwarding from a device operating in a vehicle to an SD-WAN. This process 1600 may be performed by an edge router operating in the vehicle, which may be an edge router appliance, an edge router that executes on a computer that operates in the vehicle, or an edge router that executes on a machine that executes on the computer. This process 1600 dynamically distributes data message flows among network links by predicting metrics of each network link at future locations of the vehicle. For instance, this process 1600 can be used to predict signal strength of each network link at the vehicle's future locations and select links based on the predicted signal strength.

The process 1600 begins by retrieving (at 1605) historical metrics for each link relating to past locations of the vehicle. The edge router may retrieve these metrics from a local database (e.g., if the edge router previously generated these metrics), from a server, or from another vehicle that generated the metrics. In some embodiments, the edge router retrieves these metrics by sending an application programming interface (API) request to a networking interface to request the metrics. The networking interface then sends back an API response which includes the requested metrics. In some embodiments, these metrics are performance metrics of the network links, such as signal strength metrics, transmission rate metrics, etc. In other embodiments, these metrics are non-performance metrics. Still, in other embodiments, the metrics are a combination of performance and non-performance metrics. The metrics received for each network link include metrics for multiple locations traversed by the vehicle. In some embodiments, the previous locations, the current location, and the future location of the vehicle are determined based on GPS location data provided by a GPS satellite. In other embodiments, the past, current, and future locations are determined based on cellular derived location data.

Next, for each link, the process 1600 uses (at 1610) the historical metrics to determine one or more predicted metrics at the future location of the vehicle. In some embodiments, the edge router uses the historical metrics for each link to generate a linear regression for each link. For a particular wireless network link, the edge router plots data points for metrics of the link against the locations where the metrics were collected to generate a linear regression line. This line indicates the future metrics for this link at future locations of the vehicle. Further information regarding this linear regression will be described below.

The process 1600 uses (at 1615) the predicted metrics for each link to determine one or more optimal links at the future location. The edge router determines one or more optimal links for forwarding the flows when the predicted metrics for those links at the future location exceed (or in some embodiments, meet or exceed) a particular minimum threshold. The edge router does not determine a link as optimal when the predicted metrics for that link at the particular future location does not meet or exceed the particular minimum threshold. The minimum threshold can be determined by a user or administrator. For instance, when the edge router selects links based on signal strength metrics, the edge router uses historical signal strength metrics for each link to determine the predicted signal strength at the vehicle's future location (i.e., a particular distance away from its current location). Based on the predicted signal strengths of the links, the edge router can select the optimal links for use at the future location and ensure that non-optimal links are not used at the future location. A link is considered non-optimal when its predicted signal strength falls below a particular minimum signal strength score (i.e., the minimum threshold). When a link's signal strength falls below this minimum signal strength score, data message flows sent along this link are at risk of congestion. In order to avoid this, the edge router only uses links whose predicted signal strength stays above the desired minimum.

The process 1600 then forwards (at 1620) data message flows along one or more optimal links. In some embodiments, the edge router does this before reaching the future location. In other embodiments, the edge router waits to do this until it reaches the future location. In some embodiments, the edge router, in selecting network links based on their predicted metrics, forwards all data message flows using one network link. In other embodiments, the edge router forwards different data message flows using different network links. Still, in other embodiments, the edge router forwards different data messages of a particular flow using one network link. Once the edge router forwards the data message flows using the optimal network link or links, the process 1600 ends.

As described above, some embodiments leverage a set of dynamic assessment methodologies to establish ongoing quality assessment of each of the carrier provided data links. These assessments in some embodiments measuring signal quality and estimates for bandwidth up and down on each link. SD-WAN processes (e.g., SD-WAN DMPO and other processes provide by VMware's VeloCloud technology) in some embodiments is then able to make intelligent assessment of which packets to place on each of the several link based on link quality and traffic type. For example, traffic that is meant to be highly reliable can be placed on the link deemed most reliable while traffic that may be bandwidth intensive but less sensitive to outages could be placed onto the higher speed links. Packets are given a sequence number that is embedded into the packet and captured upstream at the SD-WAN gateway device which re-sequenced these packets in their original transmission order, sending them onward to their destination from the gateway in their proper order.

Different embodiments use different methods of measuring link quality. Some embodiments use location aware spot-burst bandwidth assessment. As vehicles move at speed through the landscape, their cellular coverage conditions from the multiple carriers enabled on their SD-WAN routers may change in proportion to their speed. In short, the more rapidly vehicles move, the faster they pass through cell tower fields of coverage which may result in changing signal conditions.

To optimize bandwidth assessment, the ‘GPS’ location data provided either by satellite GPS or cellular derived location data is used to establish location and direction. A policy established on the SD-WAN device or SD-WAN orchestration layer can be established to indicate at which stepping distances speed tests will be performed, i.e. once the vehicle is X distance away from the last point of spot-testing in any direction, a new test will be performed. For example, whenever the vehicle is ½ mile away from the location of the last spot assessment a new spot assessment will be performed.

In a spot assessment, the vehicle will send a short burst of packets up and down on the targeted cellular link (a short speed test), to establish the available transmission rates in both directions, this testing itself being kept to a minimal quantity of data so as to minimize adverse effect to the ongoing SD-WAN production transmissions. The performance of a spot tests itself is designed to temporarily saturate a link so that its current maximum bandwidth in both directions can be established. For example, a chunk of data (a file), of fixed size (i.e. 250 KB), is sent to and received from a nearby SD-WAN gateway location and the duration of transmission is used to calculate the effective available bandwidth in each direction at the location of interest.

To facilitate the spot test without compromising critical traffic that requires high reliability, such traffic should be first shifted to alternate links available on the SD-WAN device. For example, if three carriers through cellular links are available to the SD-WAN device, testing link 1 would entail removal of ‘critical traffic’ from link 1 and re-distributing across links 2 and 3 during the brief period of the burst test on link 1.

For example, if the SD-WAN device has three links from three separate carriers, with estimated approximately 15 Mbit/s bandwidths down and 5 Mbit/s up on each link, in a scenario where a total of 24 Mbit/sec of traffic is currently being received and 9 Mbit/sec is being sent, these traffic streams will be initially spread across the 3 links in approximately equal measure with 8 Mbit/sec being received on each link and 3 Mbit/sec being sent on each link.

During the interval of the test, the SD-WAN device has some outbound traffic designated as ‘critical traffic’ on link 1, so this is initially skipped, and will be revisited after other links complete their tests. Link 2 is then targeted for the initial test, and there may be no critical traffic on link 2, so a burst of traffic is placed on this link in addition to the traffic load it is already carrying with the test traffic stream generating 9 Mbit/sec download speed in addition to its current traffic, yielding a download speed estimate of 17 Mbit/sec, and a total of 2.7 Mbit/sec upload for a total estimate of 5.7 Mbit/sec upload speed. Upon completion of this test and a similar test on link 3, the test resumes on link 1. However, the critical traffic is still on link 1 so it is relocated to links 2 and 3. Upon completion of the link 1 tests, the relocated traffic streams are in some embodiments resumed on link 1, and the process then repeats for links 2 and 3.

While burst testing on multiple links in parallel is possible, it is only advised if the critical path traffic flow rates can be safely redistributed across the other available links without exceeded their estimated maximum bandwidths. Once the bandwidth estimates of the 3 links are establish at the spot-test location, traffic can then be placed across these links in an optimal placement configuration based on the newly established bandwidth of each link, until the next spot-test location is reached at which time the process will repeat. The strict adherence to the distance-based testing protocol can be further optimized based on the current traffic pattern, with spot tests being delayed or skipped if all links are very active or critical traffic flows cannot be placed onto a subset of the links to facilitate a link test.

Another method uses Radio Telemetry Based Reliability Assessment. In some configurations, the cellular radios used by the SD-WAN device will enable access to radio level telemetry through an API call made to their networking interface. An example includes the Multitech r100 series, which performs LTE to ethernet bridging functions, allowing the SD-WAN device to engage with it as a generic network WAN connection. It does however also provide an API which can be interrogated by the SD-WAN device at will through the network interface to obtain real-time radio signal quality measurements such as signal strength measurements.

This capability allows for an enhanced method of assessing link quality and reliability than the above-described dynamic spot testing method can provide on its own. While the spot testing method provides ongoing bandwidth assessments, it yields less information about the future reliability of each of the underlying cellular links which may potentially degrade rapidly after a short distance in some cases due to features of the landscape, or other factors.

In this method, a regular location-based model informed by GPS based location is merged with a predictive model of signal strength generated by an ongoing linear regression model which is formed based on signal strength measurements from recent measurements taken at a regular distance such as 1/10^{th} of a mile. These historical measurements are used to predict a forward looking linear regression based line indicating likely future signal strength in the direction of travel.

In the event that the forward predicting line passes below a signal quality threshold defined by policy within the orchestration layer or SD-WAN device, the SD-WAN packet schedule will pre-emptively shift packets away from the link(s) predicted to fall below acceptable quality and only link predicted to maintain, improve, or otherwise stay above the ‘signal floor’ defined. This pre-emptive action will allow for quality to be maintained with higher probability of short micro-outages that may occur while the SD-WAN software otherwise reactively moves packets onto better links upon detection of link degradation during a next-burst spot test or in response to actually degraded network packet flows.

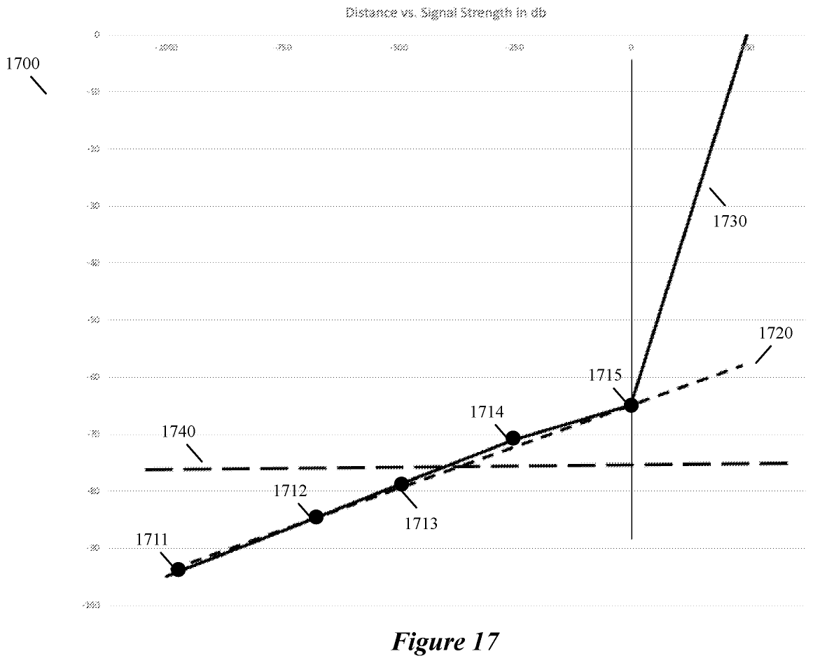

FIG. 17 illustrates an example linear regression graph 1700 generated by an edge router for selecting network links based on predicted metrics. The graph 1700 shows five collected metrics as datapoints 1711-1715. These datapoints 1711-1715 each correspond to a metric retrieved for a given wireless network link at a different location of the vehicle. In this example, metrics are collected for signal strength (in decibels (dB)) at various distances from the current location of the vehicle. A linear regression line 1720 is drawn to correlate the datapoints 1711-1715 into a single line. Using this line, a predicted signal quality line 1730 is plotted to show the predicted signal strength of the network link at future locations of the vehicle. If the predicted signal quality line 1730 were to fall below the minimum signal strength threshold 1740 set by a defined policy, the edge router would be able to determine that this link is not optimal for use along the vehicle's future route. In this example, using the minimum threshold 1740, the edge router can determine that this network link's signal strength at future locations is predicted to be above the minimum signal strength quality, and the edge router can then determine that this network link is optimal for forwarding data message flows at future locations of the vehicle.

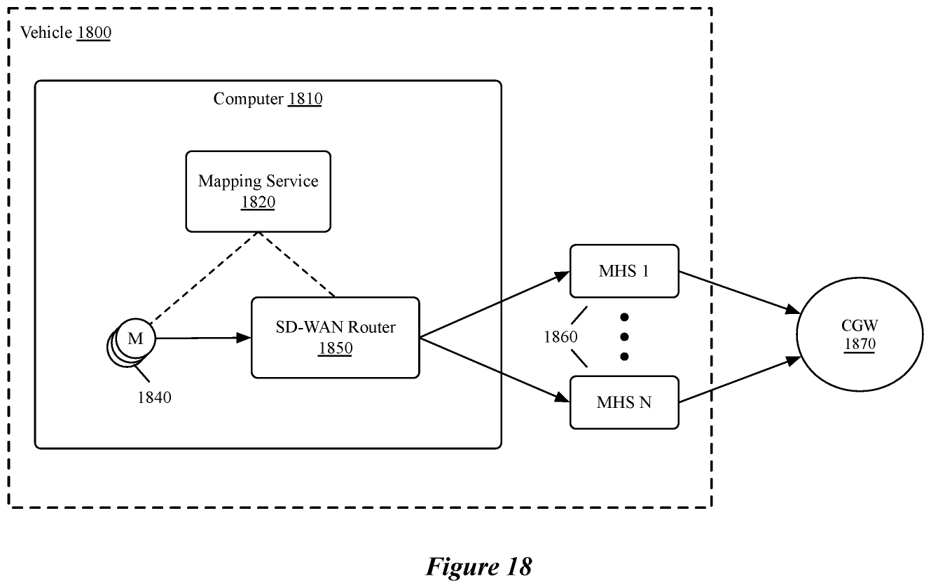

In some embodiments, a user of a vehicle uses a mapping service (i.e., a mapping application) to determine an optimal route for the vehicle to travel to a particular destination. Determining the optimal route in some embodiments considers both (1) transportation factors (e.g., trip duration, hazard avoidance, traffic congestion, transit fees, etc.) and (2) the signal strength and speed of the wireless network links used to connect an edge router of the vehicle to an SD-WAN. Some embodiments also consider QoS requirements of machines and/or applications executing in the vehicle that send data message flows to the SD-WAN. FIG. 18 illustrates an example vehicle 1800 that includes a computer 1810, a mapping service 1820, a set of one or more machines 1840, an SD-WAN router 1850, and wireless network links 1860 to connect to a cloud gateway 1870 of an SD-WAN. While the SD-WAN router 1850 is illustrated in this figure as executing on the computer 1810, in other embodiments, the SD-WAN router 1850 executes as a standalone appliance in the vehicle 1800.

The cloud gateway 1870 in some embodiments includes a router that performs data message forwarding operations to forward data messages from the vehicle 1800 to one or more destinations (e.g., edge sites, datacenter sites, other vehicles, etc.). In such embodiments, the next-hop forwarding records of the cloud gateway 1870 are routing records used by the cloud gateway 1870 to forward data messages through the SD-WAN of the vehicle 1800. The cloud gateway 1870 in some embodiments also includes middleboxes.

In some embodiments, the mapping service 1820 is an application, program, module, or set of one or more processes executing as a service engine of the computer 1810. In other embodiments, it executes as an SVM of the computer 1810. A user in some embodiments interacts with the mapping service 1810 to determine an optimal navigation route to a particular future location. In some embodiments, the mapping service 1820 determines the optimal navigation route based on (1) possible navigation routes to the particular future location, (2) the signal strength and speed of each wireless network link 1860 along each possible navigation route, and (3) QoS requirements of the machines 1840. Once an optimal navigation route is determined, the mapping service 1820 presents the optimal navigation route to the user. In some embodiments, after the user selects the optimal navigation route, the mapping service 1820 presents step-by-step instructions of the selected optimal navigation route for the user to view to move the vehicle along the selected optimal navigation route to the particular future location.

As the vehicle moves along the selected navigation route, the SD-WAN router 1850 in some embodiments dynamically distributes data message flows along various network routes using the wireless network links 1860 to forward them to the cloud gateway 1870, as described above.

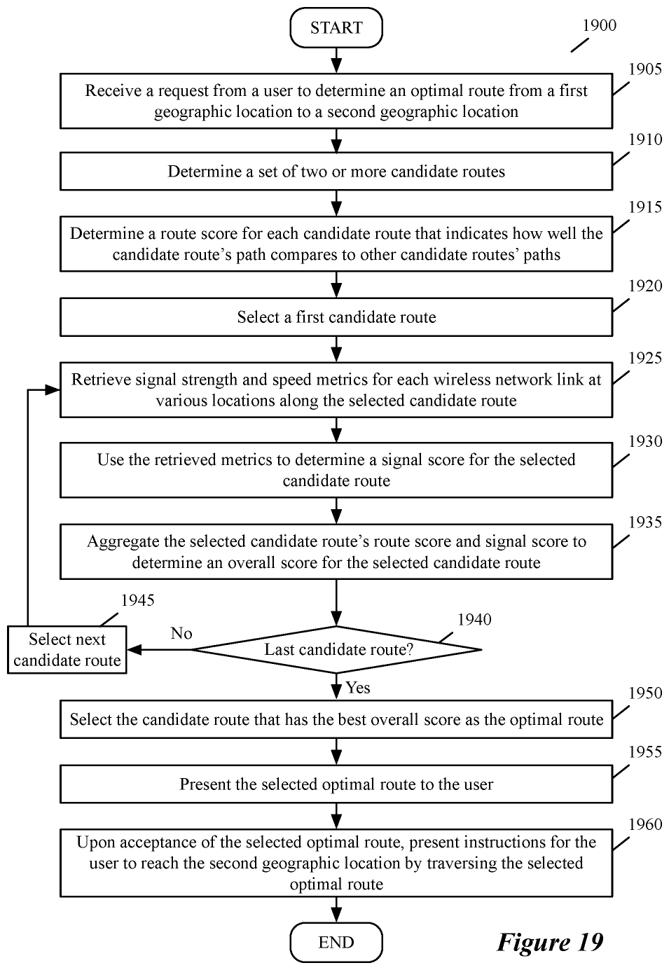

FIG. 19 conceptually illustrates a process 1900 of some embodiments for determining an optimal navigation route for a vehicle to travel from a first geographic location to a second geographic location. This process 1900 is performed in some embodiments by a mapping service (e.g., an application, program, module, SVM, etc.) operating in the vehicle. In some embodiments, the vehicle also includes an edge router that forwards data message flows from a set of one or more machines, executing on a device operating in the vehicle, to an SD-WAN along one or more network routes using several wireless network links connecting the edge router to the SD-WAN (e.g., to an edge router or gateway of the SD-WAN).

The process 1900 begins by receiving (at 1905) a request from a user to determine an optimal route from the first geographic location to the second geographic location. The mapping service in some embodiments receives, through a user interface (UI) in the vehicle, a request from the user that specifies the desired destination (i.e., the second geographic location) to which the user wishes to move the vehicle. In such embodiments, the request is received as an API request from the user. In other embodiments, the request is received through a graphical UI (GUI) in the vehicle. In these embodiments, the GUI presents selectable items for the user to request the optimal route and to input the desired destination (i.e., the second geographic location).

In some embodiments, the request from the user also specifies the considerations the user wishes the mapping service to consider when determining the optimal route. Examples of such considerations include (1) transportation factors (e.g., trip duration, hazard avoidance, traffic congestion, transit fees, etc.), (2) the signal strength and speed of the wireless network links used to connect the edge router of the vehicle to an SD-WAN, and (3) QOS requirements of the set of machines that send data message flows to the SD-WAN. In some embodiments, the request also specifies the carriers associated with the wireless network links.

Next, the process 1900 determines (at 1910) a set of two or more candidate network routes (also referred to as candidate routes) from the first geographic location to the second geography location. The mapping service in some embodiments determines multiple possible routes the vehicle can take to reach the second geographic location. In some embodiments, the mapping service determines a particular number of candidate routes. For example, the mapping service is in some embodiments configured to determine three candidate routes. This configuration is made by a set of one or more controllers that configure the mapping service and the edge router of the vehicle (such as the controller cluster 105 of FIG. 1). Conjunctively or alternatively, the mapping service determines the set of candidate routes based on QoS requirements of the machines executing on the device in the vehicle. Further information regarding selecting candidate routes based on machine QoS requirements will be described below.

After determining the set of candidate routes, the process 1900 determines (at 1915) a route score for each candidate route that indicates how well the candidate route's path compares to the other candidate routes' paths. In some embodiments, the route scores are based on the time durations of the candidate routes. In such embodiments, the mapping service determines, for each candidate route, the length of time the candidate route takes to reach the second geographic location. After determining the time durations for each candidate route, the mapping service ranks the candidate routes by time duration. For example, the mapping service orders the candidate routes from shortest time duration to longest time duration. Then, based on this ordering, the mapping service assigns each candidate a route score. In some embodiments, a high route score indicates a short time duration, and a low route score indicates a longer time duration. Further information regarding determining route scores will be described below.

At 1920, the process 1900 selects a first candidate route from the set of candidate routes. In some embodiments, the edge router selects a first candidate route at random. In other embodiments, the edge router selects a first candidate route based on one or more parameters (e.g., route length, route duration, etc.). After selecting the candidate route, the process 1900 retrieves (at 1925) signal strength and speed metrics for each wireless network link at various locations along the selected route. Because the vehicle's edge router uses multiple wireless network links to connect to the SD-WAN, the mapping service in some embodiments determines the performance of each wireless network link along each candidate route in order to determine the average performance of the connection to the SD-WAN along the candidate route. By determining the average performance of the SD-WAN connection for each candidate route, the mapping service is able to compare each candidate route based on their SD-WAN connection performance. In some embodiments, before requesting the metrics for each wireless network link, the mapping service determines which carriers are associated with the links. In such embodiments, the mapping service determines the carriers by looking to the carriers specified in the user's request received at step 1905.

For instance, a globally unique identifier (GUID) representing the vehicle's edge router is utilized in some embodiments along with an organizational identifier. When the user requests an optimal route based on signal strength and speed of the vehicle's wireless network links, the mapping service requests for the organizational identifier from a cloud-hosted registration database that stores the wireless network links' signal quality (signal strength and speed) data. In some embodiments, the GUID associated with the API endpoint is used for signal quality queries and will be also be used by the mapping service to obtain information on the radio configuration of the edge router executing in the vehicle. In such embodiments, this enables the mapping service to identify which carriers and connection types are included in the vehicle where the user is making the route queries (i.e., the starting location of the vehicle). The mapping service application in some embodiments then takes the specifics of the user's cellular connectivity configuration attached to the SD-WAN into account when evaluating optimal routes.

In some embodiments, metrics associated with the different wireless network links specify data regarding different carriers' signal quality and speed by technology type (e.g., 4G, 5G, etc.). This data is in some embodiments continuously updated by multiple vehicles that periodically drive along different routes to collect this data. For instance, these vehicles perform periodic spot tests (as described above), which allow for other vehicles to optimize their use of multiple wireless network links and to make predictive assessments of signal quality at future locations. A vehicle that is to perform a spot test at a particular location in some embodiments forgoes the performance of the spot test because such data was stored in the cloud data store within a particular time period (e.g., within the last 15 minutes). The different carriers of the wireless network links in some embodiments provide the signal strength and speed metrics of their links for use by vehicles for selecting optimal routes.

The data collected during the spot tests is in some embodiments stored in a cloud-based data store (e.g., a cloud database). For each spot test performed for a wireless network link, the associated data stored in the data store in some embodiments includes an upload speed of the wireless network link, a download speed of the wireless network link, and timestamps associated with each speed. In some embodiments, the data store (i.e., a controller that configures the data store, such as a cloud-based controller) calculates a moving average of a last set of measurements to provide smoothing to the signal quality data at each location in order to offer a more normative view of the signal quality at the location. Different embodiments may utilize any suitable smoothing method to reduce volatility in measured signal data. These smoothing methods in some embodiments consider historical measurements and protect against anomalies that may misrepresent normal signal quality at a location.

In some embodiments, the cloud-based data store does not store measurements for the wireless network links taken at a same location by multiple vehicles that perform these measurements. In such embodiments, a degree of randomization is taken along routes for collecting initial measurements. In some embodiments, multiple participating companies (e.g., telecommunication network providers, such as AT&T, Verizon, T-Mobile, Orange, etc.) choose to contribute the values of their own private signal quality measurements to a public or shared signal quality data store that has appropriate anonymity and security safeguards. In such embodiments, a more detailed signal quality data store that includes overlapping datasets derived from multiple contributors is available publicly or by way of a subscription service in which subscribers pay to consume the data during key routing operations. In some embodiments, the owner of the subscription service is the company (i.e., the telecommunication network provider) providing the in-vehicle edge router. In other embodiments, it is a different company whose data is sold by the owner of the in-vehicle edge router.

After retrieving the signal strength and speed metrics for each wireless network link along the selected candidate route, the process 1900 uses (at 1930) the retrieved metrics to determine a signal score for the selected candidate route. In some embodiments, the mapping service scores the candidate route based on its average signal strength and average speed along the entire route. Further information regarding determining signal scores will be described below.

Next, the process 1900 aggregates (at 1935) the selected candidate route's route score and signal score to determine an overall score for the selected candidate route. The mapping service in some embodiments aggregates the two scores by taking the average of the two values. In other embodiments, the mapping service aggregates the two scores based on weights assigned to the two scores. For example, the mapping service in some embodiments aggregates the scores using the equation 1, where z is the overall score, x is the route score, and y is the signal score.

$$z = 3 x + y . \qquad ( 1 )$$

As shown, a weight of 3 is assigned to the route score, and a weight of 1 is assigned to the signal score. By aggregating the scores using this equation, the mapping service creates an overall score for the candidate route that is influenced more by the route score than the signal score. In some embodiments, weights are received at the mapping service by the user (e.g., in the request sent at step 1905). In other embodiments, the mapping service is configured (e.g., by a controller set) to use the same weights for every overall score it determines.

At 1940, the process 1900 determines (at 1940) whether the selected candidate route is the last candidate route for which it has to determine an overall score. For instance, if the selected candidate route is the first candidate route of the set of two or more candidate routes, it is not the last selected route. If the process 1900 determines that it is not the last candidate route, the process selects (at 1945) the next candidate route in the set of candidate routes, and returns to step 1925. In some embodiments, the edge router selects the next candidate route by selecting a candidate route from all candidate routes that have not yet been selected at random.

If the process 1900 determines that it is the last candidate route, the process 1900 selects (at 1950) the candidate route that has the best overall score as the optimal route for the vehicle. The mapping service compares each overall score determined for each candidate route to determine which candidate route has the best overall score. In some embodiments, the best overall score is the largest overall score. In other embodiments, the best overall score is the smallest overall score.

Then, the process 1900 presents (at 1955) the selected optimal route to the user. In embodiments where the user requests for the optimal route through a UI, the mapping service presents the optimal route in the UI (e.g., in an API). In embodiments where the user requests for the optimal route through a GUI, the mapping service presents the optimal route in the GUI (e.g., as a selectable item). The selected optimal route is presented to the user in some embodiments to allow the user to accept or deny using this route to reach the second geographic location.

Lastly, upon acceptance of the selected optimal route, the process 1900 presents (at 1960) instructions for the user to reach the second geographic location by traversing the selected optimal route. In some embodiments, the user accepts the selected optimal route as the route to take to get to the second geographic location. The mapping service receives this acceptance, and in turn presents step-by-step instructions to the user that instruct the user along the selected optimal route. After presenting the instructions for the user to reach the second geographic location by traversing the selected optimal route, the process 1900 ends.

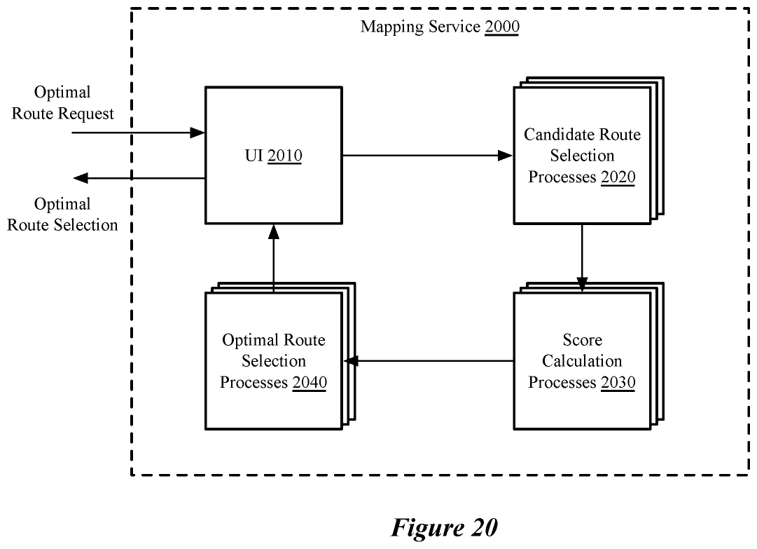

FIG. 20 illustrates an example mapping service that determines optimal routes for a moving vehicle. The mapping service 2000 in this example includes a UI 2010, a set of candidate route selection processes 2020, a set of score calculation processes 2030, and a set of optimal route selection processes 2040. In some embodiments, the mapping service is implemented as a set of applications, modules, or machines on a device (e.g., a computer) in the vehicle. The vehicle also includes, in some embodiments, a set of machines and an edge router that connects the set of machines to an SD-WAN using several wireless network links. In some embodiments, the wireless network links are provided by different carriers and are different connection types (e.g., 4G, 5G, etc.).

The UI 2010 facilitates communications with a user of the vehicle. In some embodiments, the UI 2010 is a GUI implemented on a computer in the vehicle. The UI 2010 receives, from the user, a request for an optimal route. This request in some embodiments includes the desired destination the user wishes to move the vehicle and the types of considerations the user wishes the mapping service 2000 to consider in determining the optimal route to the desired destination. Examples of such considerations include (1) transportation factors (e.g., trip duration, hazard avoidance, traffic congestion, transit fees, etc.), (2) the signal strength and speed of the wireless network links used to connect the edge router of the vehicle to the SD-WAN, and (3) QoS requirements of the set of machines that send data message flows to the SD-WAN. The request also specifies in some embodiments the carriers of the different wireless network links. In some embodiments, the request specifies the current location of the vehicle (i.e., the starting location for the requested optimal route). In other embodiments, the request does not specify the current location of the vehicle, and the mapping service 2000 determines it using GPS location data or cellular derived data.

After receiving the optimal route request from the user, the UI 2010 passes the requests to the set of candidate route selection processes 2020 to determine a set of two or more candidate routes to the desired destination. In some embodiments, because the request specifies QoS requirements of the set of machines, the set of candidate routes is determined based on them. In other embodiments, the candidate route selection processes 2020 retrieve the QoS requirements from an orchestration layer of the SD-WAN. After determining the candidate routes to the desired destination, the candidate route selection processes 2020 pass the candidate routes to the score calculation processes 2030. For each of the candidate routes, the score calculation processes 2030 determine a route score and a signal score, and aggregate both of these scores into an overall score for the candidate route.

Once each candidate route has an associated overall score, the score calculation processes 2030 pass the candidate routes and their overall scores to the optimal route selection processes 2040. Then, the optimal route selection processes 2040 compare the overall scores to determine the candidate route score with the best overall score. In some embodiments, the best overall score is the largest overall score. In other embodiments, the best overall score is the smallest overall score. After determining the candidate route with the best overall score, the optimal route selection processes 2040 select this route as the optimal route to the desired destination, and present the selected optimal route to the user through the UI 2010.

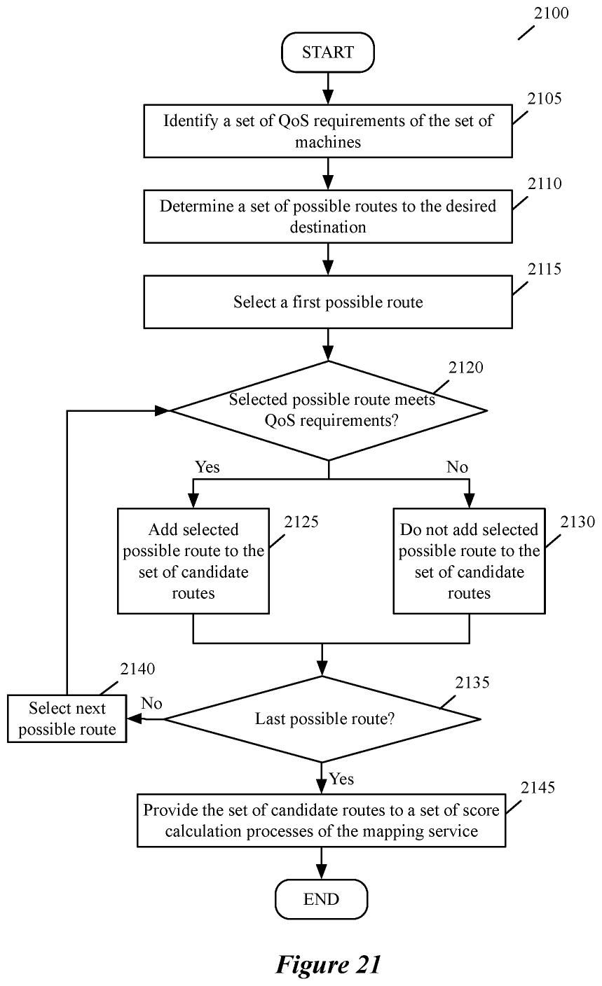

FIG. 21 conceptually illustrates a process 2100 of some embodiments for determining a set of candidate routes to a desired destination for a vehicle. This process 2100 is performed in some embodiments by a mapping service executing in the vehicle, more specifically by candidate route selection processes of a mapping service (such as the candidate route selection processes 2020 of FIG. 20). The process 2100 is performed in some embodiments based on QoS requirements of machines executing in the vehicle that send flows to an SD-WAN using an edge router and a set of wireless network links. In some embodiments, the process 2100 starts when the candidate route selection processes receive, from a UI of the mapping service, a user's request to determine an optimal route to the desired destination.

The process 2100 begins by identifying (at 2105) a set of QOS requirements of the set of machines executing in the vehicle. In some embodiments, a user of the vehicle specifies the QoS requirements in their optimal route request, so the candidate route selection processes receive the QoS requirements directly through the UI. In other embodiments, the QoS requirements are part of a set of policies established in the SD-WAN's orchestration layer.

In some embodiments, the QoS requirements are related to signal strength and/or bandwidth levels the machines require along the wireless network links to the SD-WAN. For example, a QoS requirement of a first machine in some embodiments requires a minimum signal level of −70 db, meaning that the first machine will not accept a signal strength of less than −70 db. As another example, a QoS requirement of a second machine in some embodiments requires a minimum upload speed of 2 Mbit/sec and a minimum download speed of 3 Mbit/sec download, meaning that the second machine will not accept any slower upload and download speeds. The set of QoS requirements can include any suitable QOS requirements for any number of machines executing in the vehicle, and each machine can have any number of QoS requirements.

After identifying the set of QoS requirements, the process 2100 determines (at 2110) a set of possible routes to the desired destination. The candidate route selection processes in some embodiments determines all possible routes from the vehicle's current location to the desired destination. In some embodiments, this determination is made based on various transportation factors, such as trip duration, hazard avoidance, traffic congestion, transit fees, etc. These possible routes are not, in some embodiments, determined based on QoS requirements of the machines and the signal quality/strength of each wireless network link along the routes. In some embodiments, the possible routes are determined by third-party servers that (1) receive start and end locations for a route (i.e., the current location of the vehicle and the desired destination) and (2) provide the possible routes. In other embodiments, the candidate route selection processes use common route identification processes to identify the multiple possible routes to the desired destination.

Next, the process 2100 selects (at 2115) a first possible route. In some embodiments, the edge router selects a first possible route at random. In other embodiments, the edge router selects a first possible route based on one or more parameters (e.g., route length, route duration, etc.). After selecting the possible route, the process 2100 determines (at 2120) whether the selected possible route meets the QoS requirements. The candidate route selection processes in some embodiments determines whether the wireless network links meet the machines' QoS requirements at all points along the selected possible route. For example, if the QoS requirement of a machine requires a bandwidth of at least 15 Mbit/s, the selected possible route must have a bandwidth of 15 Mbit/s or higher at each point along the route.

If the process 2100 determines that the selected possible route does meet the set of QoS requirements, the process 2100 adds (at 2125) the selected possible route to the set of candidate routes to the desired destination. This set of candidate routes includes all possible routes to the desired destination that meet the QoS requirements. If the process 2100 determines that the selected possible route does not meet the set of QoS requirements, the process 2100 does not add (at 2130) the selected possible route to the set of candidate routes to the desired destination.

At 2135, the process 2100 determines whether the selected possible route is the last possible route in the set of possible routes to the desired destination. For instance, if the selected possible route is the first possible route of the set of possible routes, it is not the last selected possible route. If the process 2100 determines that it is not the last possible route, the process selects (at 2140) the next possible route in the set of possible routes, and returns to step 2120.

If the process 2100 determines that it is the last possible route, the process 2100 provides (at 2145) the set of candidate routes to a set of score calculation processes of the mapping service. After determining the candidate routes to the desired destination, the candidate route selection processes pass them to the score calculation processes in order to score the candidate routes based on their route (e.g., time duration) and the signal strength/speed of the wireless network links along them. After providing the set of candidate routes to the score calculation processes, the process 2100 ends.

In some embodiments, none of the candidate routes to the desired destination do not meet the QoS requirements of the machines. In such embodiments, after the candidate route selection processes do not add any possible routes to the set of candidate routes, the candidate route selection processes send a notification message to the user through the UI of the mapping service that no routes to the desired location meet the machines' QoS requirements. After receiving the notification, the user in some embodiments sends an updated request to the mapping service, through the UI, requesting an optimal route to the desired destination that does not have to consider the QoS requirements.

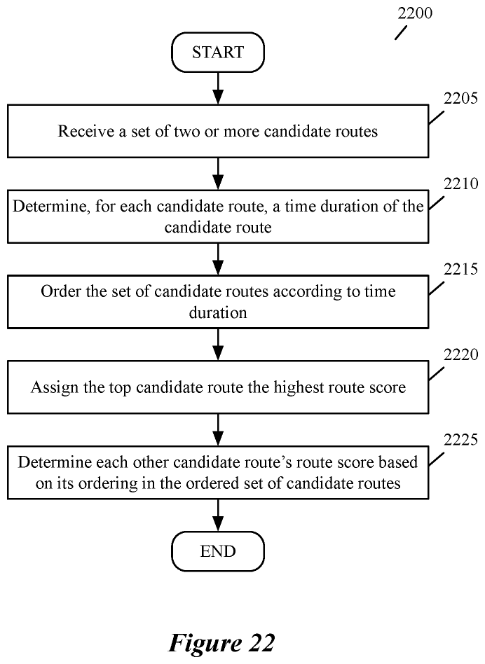

After determining candidate routes that meet the QoS requirements of the machines, the candidate routes in some embodiments are scored in order to determine which route is the optimal route. FIG. 22 conceptually illustrates a process 2200 of some embodiments for calculating route scores for a set of two or more candidate routes. This process 2200 is performed in some embodiments by a set of score calculation processes of a mapping service executing in a vehicle (such as the score calculation processes 2030 of FIG. 20). The process 2200 is performed in some embodiments for a set of candidate routes determined for a user of a vehicle that wishes to move the vehicle to a particular destination. Determining route scores is performed in some embodiments in order to normalize the route metrics for each candidate route. Normalizing route metrics (e.g., time duration, distance length, speed, traffic, amount of fuel used, number of stops) allows for candidate routes to be quantitatively compared. The process 2200 will be described using the example of determining route scores based on time duration of candidate routes. However, in other embodiments, route scores are determined based on other factors, such as trip distance of each candidate route.

The process 2200 begins by receiving (at 2205) a set of two or more candidate routes from a set of candidate route selection processes of the mapping service. The score calculation processes of the mapping service receive the candidate routes determined by the candidate route selection processes of the mapping service. After receiving the set of candidate routes, the process 2200 determines (at 2210), for each candidate route, a time duration of the candidate route. In some embodiments, the candidate route selection processes specify each candidate route's time duration when providing the candidate routes to the score calculation processes.

Next, the process 2200 orders (at 2215) the set of candidate routes according to time duration. The score calculation processes organize the set of candidate routes from smallest time duration to largest time duration. At 2220, the process 2200 assigns the top candidate route the highest route score. Using the ordered set of candidate routes, the score calculation processes are able to determine which candidate route has the smallest (i.e., best) time duration. This candidate route is then determined as the best candidate route, and is assigned the highest route score. In some embodiments, route scores are on a scale of 1-10. In such embodiments, the highest route score is 10. In other embodiments, route scores are on a percentage scale of 0%-100%. In these embodiments, the highest route score is 100%.

After assigning the top candidate route the highest route score, the process 2200 determines (at 2225) each other candidate route's route score based on its ordering in the ordered set of candidate routes. The score calculation processes determines the other candidate routes' route scores by comparing their time durations to the top candidate route's time duration. For example, there are 10 candidate routes in some embodiments, and the score calculation processes evaluate them based on their ordering according to trip duration. To determine the candidate routes' route score, the score calculation processes in some embodiments use Equation 2, where x is the value of the number order of the candidate route.

$$Route Score = 1 / ( \frac{x}{1} ) . \qquad ( 2 )$$

The value of the number order of the candidate route is divided by 1 because 1 is the value of the number order of the top candidate route. Using this equation, the score calculation processes determine route scores (in percentage values) for the candidate routes. After determining route scores for each candidate route, the process 2200 ends. In some embodiments, the score calculation processes use these route scores, along with signal scores determined for the candidate routes, to determine overall scores for the candidate routes. These overall scores are used in some embodiments to determine the optimal route out of the candidate routes.

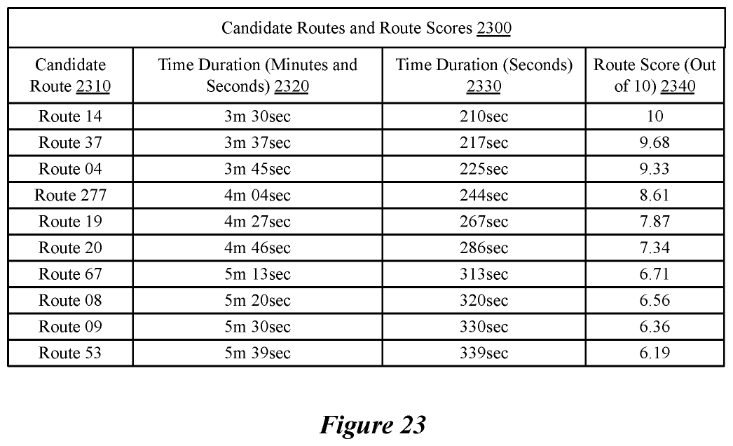

FIG. 23 illustrates an example table 2300 that specifies candidate routes ordered by time duration and their router scores. In this figure, the table 2300 includes a first column 2310 specifying the candidate route, a second column 2320 specifying the candidate route's time duration in minutes and seconds, a third column 2330 specifying the candidate route's time duration in seconds, and a fourth column 2340 specifying the candidate route's route score. As shown, the top candidate route (Route 14) is assigned the top route score of 10. Each other candidate route score is assigned its route score based on its time duration in comparison to the top candidate route. These route scores 2340 normalize the time durations of the candidate routes 2310 in order to compare them and in order to score each candidate route based on their time duration and the signal strength of the wireless connectivity along the candidate route.

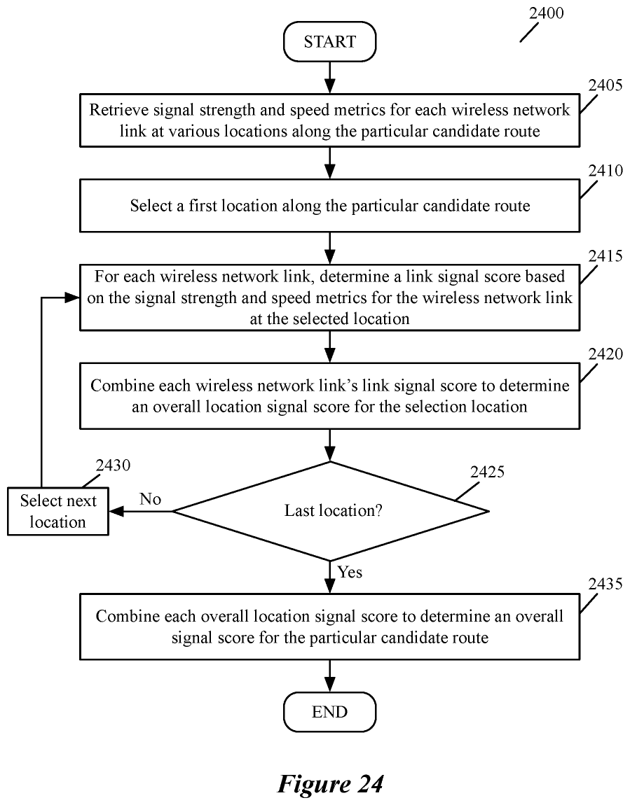

As discussed previously, the score calculation processes also determine signal scores for candidate route. FIG. 24 conceptually illustrates a process 2400 of some embodiments for calculating a signal score for a particular candidate route. This process 2400 is performed in some embodiments by a set of score calculation processes of a mapping service executing in a vehicle (such as the score calculation processes 2030 of FIG. 20). The process 2400 is performed in some embodiments for each of a set of candidate routes determined for a user of a vehicle, that includes an edge router connecting to an SD-WAN using several wireless network links, that wishes to move the vehicle to a particular destination.

In some embodiments, the score calculation processes determine signal scores for candidate routes after determining route scores for the candidate routes. In other embodiments, the score calculation processes determine the signal scores before determining the route scores. Still, in other embodiments, the score calculation processes determine the signal and route scores simultaneously. The process 2400 will be described using the example of determining a signal score based on signal strength and speed of several wireless network links along the particular candidate route. However, a signal score can be determined based on any suitable wireless network link factors and wireless connectivity metrics.

The process 2400 begins by retrieving (at 2405) signal strength and speed metrics for each wireless network link at various locations along the particular candidate route. In some embodiments, the score calculation processes send an API request to a signal quality data score that scores these metrics for the various wireless network links. As discussed previously, the mapping service in some embodiments uses a GUID associated with the vehicle's edge router when requesting information regarding the vehicle's wireless network links form an API endpoint. In such embodiments, the score calculation processes query this GUID from the API endpoint and receives the configuration information indicating the carriers available to the user in the vehicle.

Next, the process 2400 selects (at 2410) a first location along the particular candidate route. In some embodiments, the score calculation processes selects different locations along the candidate route at a particular distance interval in order to determine the an overall signal score for the candidate route. This particular distance is every ¼ mile in some embodiments, and every 1/10 mile in other embodiments. Any suitable distance can be used.

After selecting the location, for each wireless network link, the process 2400 determines (at 2415) a link signal score based on the signal strength and speed metrics for the wireless network link at the selected location. For example, at the selected location, the signal strength measurements of the wireless network links are used in some embodiments to generate numeric scores, e.g., from 1 to 10, with 10 being assigned to any signal strength with a value better than-40 db, while lower strength measurements are proportionately assigned lower numeric scores.

For speed measurements of the wireless network links, numeric scores of 1 to 10 are similarly used in some embodiments, such that 10 is any speed measurement above a specified maximum speed, such as 50 mbit/sec, and lower speed measurements are proportionally assigned lower numeric scores. After determining numeric scores for signal strength and speed for each wireless network link at the selected location, each wireless network link's link signal score is determined by averaging their numeric scores for speed and signal strength at the selected location.

In some embodiments, for the selected location, the score calculation processes do not have a signal strength or speed metric for one or more wireless network links. In such embodiments, a value for the unknown measurement is inferred. In some embodiments, to infer a particular measurement, the score calculation processes calculate a value based on the proximity to nearby locations that are associated with measurements of the same type and for the same wireless network link that the selected location does not have. For example, for a selected location that is halfway between two nearby locations with established metrics, the score calculation processes in some embodiments take an average of those the established metrics in order to infer the metric at the selected location. Alternatively, if the selected location is ¾ toward one of the two locations, then the measurement inference assigns the closer location more weight by using Equation 3, where a is the distance from the farther location, x is the distance from the closer location, y is the measurement value of the closer location, and b is the measurement value of the farther location.

$$Inferred Measurement = ( \frac{a}{x} ) * y + ( \frac{x}{a} ) * b . \qquad ( 3 )$$

After determining a link signal score for each wireless network link at the selected location, the process 2400 combines (at 2420) each wireless network link's link signal score to determine an overall location signal score for the selected location. By averaging each wireless network link's score at the selected location into one location signal score, the score calculation processes quantitatively determine the average signal strength and speed of all of the wireless network links at the selected location.

At 2425, the process 2400 determines whether the selected location is the last location of the particular candidate route for which the process 2400 needs to determine an overall location signal score. If the process 2400 determines that it is not the last location, the process 2400 selects (at 2430) the next location, and returns to step 2415 to determine an overall location signal score for the newly selected location.

If the process 2400 determines that it is the last location, the process 2400 combines (at 2435) each overall location signal score to determine an overall signal score for the particular candidate route. The score calculation processes in some embodiments aggregates the overall location signal scores into a single overall signal score that represents the average signal strength and speed along the particular candidate route. In some embodiments, the score calculation processes determines the overall signal score by summing the average of the overall location signal scores. In other embodiments, the score calculation processes determines the overall signal score by summing the max value of the overall location signal scores. Any other suitable score aggregation formulas may be used. After determining the overall signal score for the particular candidate route, the process 2400 ends.

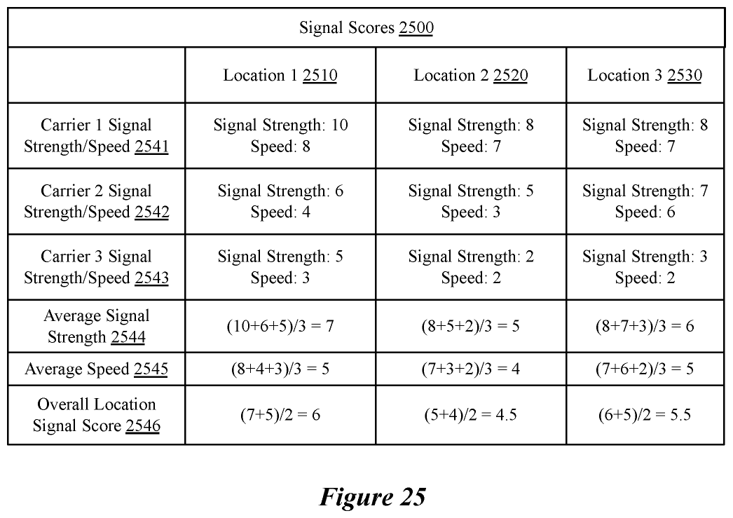

FIG. 25 illustrates an example table 2500 that specifies the various signal scores computed for a particular candidate route by a mapping service (i.e., by a set of score calculation processes of the mapping service). The table 2500 includes a first column 2510 for a first location of the candidate route, a second column 2520 for a second location of the candidate route, and a third column 2530 for a third location of the candidate route.

For each location, the table 2500 specifies a first carrier's signal strength and speed 2541 at the location, a second carrier's signal strength and speed 2542 at the location, a third carrier's signal strength and speed 2543 at the location, the location's average signal strength 2544, the location's average speed 2545, and the location's overall location signal score 2546.

For example, for the first location 2510, the first carrier's signal strength is 10, the first carrier's speed is 8, the second carrier's signal strength is 6, the second carrier's speed is 4, the third carriers' signal strength is 5, the third carrier's speed is 3, the average signal strength is 7, the average sped is 5, and the overall location signal score is 6.

Using the overall location signal scores for each of the locations, the candidate route's overall signal score can be averaged. Using this example, the overall location signal scores are 6, 4.5, and 5.5, so the overall signal score is 5.3.

While some embodiments average the signal strength and quality of each wireless network link equally (as in FIGS. 24 and 25), other embodiments weigh the wireless network links differently when computing the overall signal score for a route. In such embodiments, a mapping service determines the overall signal strength and speed along a candidate route for each individual wireless network link, and then sums these values according to a set of weights. For example, for a candidate route, the mapping service in some embodiments determines a first average link score for a first wireless network link to be 5, a second average link score for a second wireless network link to be 7, and a third average link score for a third wireless network link to be 4. Each of these average link scores represent the average signal strength and speed of a wireless network link along the entire candidate route.

Using a set of weights (e.g., assigned by a user of the vehicle), the mapping service combines the average link scores to compute the signal score for the route. If the weight for the first link is 0.5, the weight for the second link is 0.3, and the weight for the third weight is 0.2, the mapping service combines the average link scores by summing 0.5*5+0.3*7+0.2*4, so the signal score for the candidate route is 5.4. By computing the signal score based on weights assigned to the individual wireless network links, the user has more control over which wireless network link they want to consider more in determining the optimal route for the vehicle.

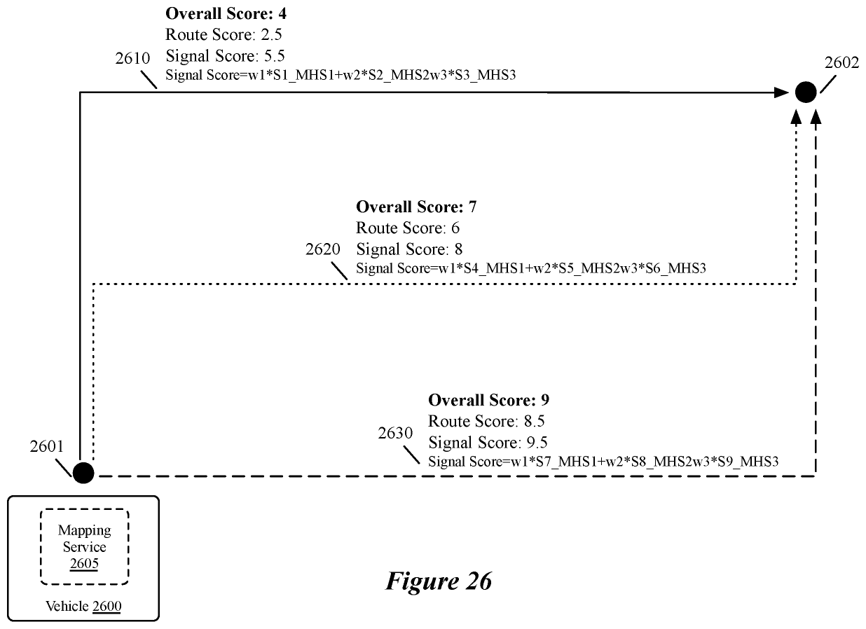

As discussed previously, a mapping service of a vehicle in some embodiments scores multiple candidate routes based on (1) route factors (e.g., time duration, distance length, etc.), (2) signal factors of the wireless network links that connect the vehicle to an SD-WAN, and/or (3) QoS requirements of the machines executing in the vehicle. Using these scores, the mapping service determines the optimal route to move the vehicle from a first geographic location to a second geographic location. FIG. 26 illustrates an example vehicle 2600 operated by a user that wishes to move the vehicle from a first location 2601 to a second location 2602. The vehicle 2600 includes a set of machines that connect to an SD-WAN through an edge router of the vehicle 2600 using multiple wireless network links, (similarly to vehicle 1800 of FIG. 18). These components of the vehicle 2600 are not illustrated for simplicity. The vehicle also includes a mapping service 2605 that determines optimal routes for the vehicle 2600.

To travel from the first location 2601 to the second location 2602, the mapping service 2605 determines three candidate routes 2610-2630. The first candidate route 2610 is denoted using a solid line, the second candidate route 2620 is denoted using a short-dashed line, and the third candidate route 2630 is denoted using a long-dashed line.

The first candidate route 2610 has an overall score of 4, which is based on a route score of 2.5 and a signal score of 4.5. The second candidate route 2620 has an overall score of 7, which is based on a route score of 6 and a signal score of 8. The third candidate route 2630 has an overall score of 9, which is based on a route score of 8.5 and a signal score of 9.5. In this example, each signal score is computed by summing an average link score for each wireless network link along the entire route according to a set of weights assigned to the wireless network links. In other embodiments, signal scores are computed based on average link quality of all the wireless network links at various locations (e.g., as described in process 2400 of FIG. 24).

Based on these overall scores computed by the mapping service 2605, the mapping service 2605 selects the third route 2630 as the optimal route for the vehicle 2600 to reach the second location 2602. After receiving this selection, the user in some embodiments accepts the third route 2630 as the route to take, and the mapping service 2605 provides to the user, through a UI (e.g., in a GUI), step-by-step instructions for the user to follow to reach the second location 2602 using the third route 2630.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

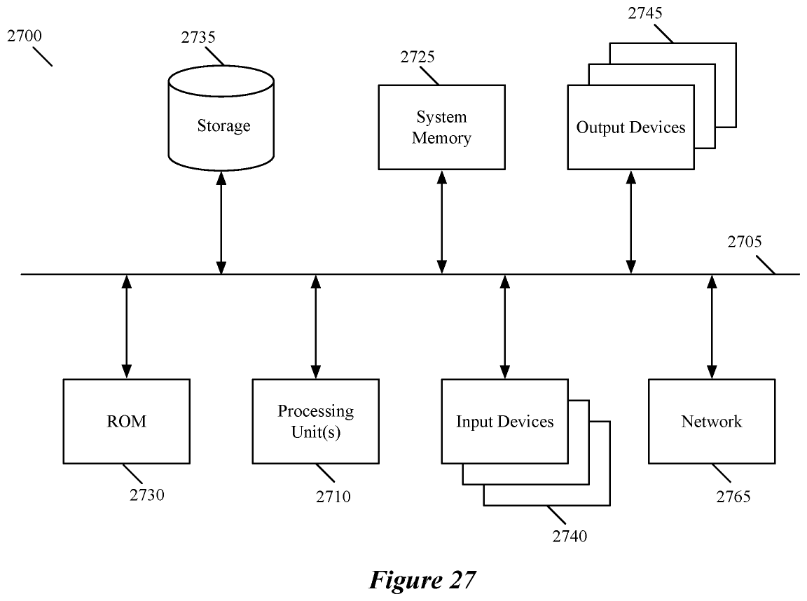

FIG. 27 conceptually illustrates a computer system 2700 with which some embodiments of the invention are implemented. The computer system 2700 can be used to implement any of the above-described computers and servers. As such, it can be used to execute any of the above described processes. This computer system includes various types of non-transitory machine readable media and interfaces for various other types of machine readable media. Computer system 2700 includes a bus 2705, processing unit(s) 2710, a system memory 2725, a read-only memory 2730, a permanent storage device 2735, input devices 2740, and output devices 2745.

The bus 2705 collectively represents all system, peripheral, and chipset buses that communicatively connect the numerous internal devices of the computer system 2700. For instance, the bus 2705 communicatively connects the processing unit(s) 2710 with the read-only memory 2730, the system memory 2725, and the permanent storage device 2735.

From these various memory units, the processing unit(s) 2710 retrieve instructions to execute and data to process in order to execute the processes of the invention. The processing unit(s) may be a single processor or a multi-core processor in different embodiments. The read-only-memory (ROM) 2730 stores static data and instructions that are needed by the processing unit(s) 2710 and other modules of the computer system. The permanent storage device 2735, on the other hand, is a read-and-write memory device. This device is a non-volatile memory unit that stores instructions and data even when the computer system 2700 is off. Some embodiments of the invention use a mass-storage device (such as a magnetic or optical disk and its corresponding disk drive) as the permanent storage device 2735.

Other embodiments use a removable storage device (such as a flash drive, etc.) as the permanent storage device. Like the permanent storage device 2735, the system memory 2725 is a read-and-write memory device. However, unlike storage device 2735, the system memory is a volatile read-and-write memory, such a random access memory. The system memory stores some of the instructions and data that the processor needs at runtime. In some embodiments, the invention's processes are stored in the system memory 2725, the permanent storage device 2735, and/or the read-only memory 2730. From these various memory units, the processing unit(s) 2710 retrieve instructions to execute and data to process in order to execute the processes of some embodiments.

The bus 2705 also connects to the input and output devices 2740 and 2745. The input devices enable the user to communicate information and select commands to the computer system. The input devices 2740 include alphanumeric keyboards and pointing devices (also called “cursor control devices”). The output devices 2745 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 27, bus 2705 also couples computer system 2700 to a network 2765 through a network adapter (not shown). In this manner, the computer can be a part of a network of computers (such as a local area network (“LAN”), a wide area network (“WAN”), or an Intranet, or a network of networks, such as the Internet. Any or all components of computer system 2700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. In addition, a number of the figures (including FIGS. 5, 6, 12, 14, 16, 19, 21, 22, and 24) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

1. A method for selecting a route for a vehicle navigating from a first location to a second location, the method comprising:
for each of a set of two or more candidate navigation routes from the first location to the second location:
computing, for the candidate navigation route, a first-metric route score representing a first quality of the candidate navigation route according to a first set of one or more route navigation metrics relating to the vehicle's navigation from the first location to the second location; and
computing, for the candidate navigation route, a second-metric route score representing a second quality of the candidate navigation route according to a second set of one or more wireless connectivity metrics relating to connectivity of one or more wireless devices operating in the vehicle; and
based on the computed first and second metric route scores, using one navigation route from the set of candidate navigation routes to provide navigation instructions for the vehicle's navigation from the first location to the second location.

2. The method of claim 1, wherein the vehicle comprises an edge router that forwards data message flows from a set of one or more machines, executing on a device operating in the vehicle, to a software-defined wide area network (SD-WAN) using a plurality of wireless network links.

3. The method of claim 2 further comprising determining the set of candidate navigation routes based on a set of quality of service (QOS) requirements of the set of machines.

4. The method of claim 3, wherein the QoS requirements are specified by a user of the vehicle through a user interface (UI).

5. The method of claim 3, wherein a particular machine requires a minimum signal strength of the plurality of wireless network links such that each candidate navigation route must meet the minimum signal strength at each location along the candidate navigation route.

6. The method of claim 3, wherein a particular machine requires a minimum speed of the plurality of wireless network links such that each candidate navigation route must meet the minimum speed at each location along the candidate navigation route.

7. The method of claim 3, wherein a particular machine requires a minimum signal strength and a minimum speed of the plurality of wireless network links such that each candidate navigation route must meet the minimum signal strength and the minimum speed at each location along the candidate navigation route.

8. The method of claim 2, wherein the set of wireless connectivity metrics comprise metrics related to one or more of signal strength and speed of the plurality of wireless network links.

9. The method of claim 8, wherein determining the second-metric route score comprises:
for each candidate navigation route:
collecting signal strength and speed metrics for each wireless network link indicating the signal strength and speed of the wireless network link at various locations along the candidate navigation route;
using the collected signal strength metrics for the plurality of wireless network links to determine an average signal strength of the plurality of wireless network links along the candidate navigation route;
using the collected speed metrics for the plurality of wireless network links to determine an average signal speed of the plurality of wireless network links along the candidate navigation route; and
aggregating the average signal strength and the average signal speed to compute the second-metric route score for the candidate navigation route.

10. The method of claim 2, wherein the edge router is one of (i) an edge router appliance, (ii) an edge router that executes on a computer that operates in the vehicle, or (iii) an edge router that executes on a machine that executes on the computer.

11. The method of claim 10, wherein the set of machines comprises one or more of virtual machines (VMs), Pods, and containers.

12. The method of claim 1, wherein each first-metric route score for each candidate navigation route indicates how well the candidate navigation route's path compares to other candidate navigation routes' paths.

13. The method of claim 1, wherein the set of route navigation metrics comprise metrics related to one or more of time duration of the candidate navigation route, speed along the candidate navigation route, traffic along the candidate navigation route, an amount of fuel to be used along the candidate navigation route, and a number of stops along the candidate navigation route.

14. The method of claim 1, wherein computing the first-metric route score comprises:
determining a time duration for the candidate navigation route; and
normalizing the time duration to compute the first-metric route score.

15. The method of claim 1 further comprising, before computing the first and second metric route scores, receiving, from a user of the vehicle through a user interface (UI), a request to provide optimal navigation instructions for the vehicle's travel from the first location to the second location.

16. The method of claim 1 further comprising, for each candidate navigation route, aggregating the first and second metric route scores using a set of weights to compute an overall score for the candidate navigation route, wherein using the one route to provide the navigation instructions based on the computed first and second metric route scores comprises selecting a particular candidate navigation route that has a best overall score as the one navigation route.

17. The method of claim 16, wherein a first weight is associated with the first-metric route score and a second, lower weight is associated with the second-metric route score such that the overall score is affected more by the first-metric route score than the second-metric route score.

18. The method of claim 16, wherein a first weight is associated with the first-metric route score and a second, higher weight is associated with the second-metric route score such that the overall score is affected more by the second-metric route score than the first-metric route score.

19. The method of claim 1, wherein the navigation instructions comprise turn-by-turn instructions comprising at least one of visual output and audio output to a user interface (UI).

20. A non-transitory machine readable medium storing a program for execution by at least one processing unit for selecting a route for a vehicle navigating from a first location to a second location, the program comprising sets of instructions for:
for each of a set of two or more candidate navigation routes from the first location to the second location:
computing, for the candidate navigation route, a first-metric route score representing a quality of the candidate navigation route according to a first set of one or more route navigation metrics relating to vehicles navigation from the first location to the second location; and
computing, for the candidate navigation route, a second-metric route score representing a quality of the candidate navigation route according to a second set of one or more wireless connectivity metrics relating to connectivity of one or more wireless devices operating on the vehicle; and
based on the computed first and second metric route scores, using one navigation route from the set of candidate navigation routes to provide navigation instructions for the vehicle's navigation from the first location to the second location.
